(19) United States
(12) Patent Application Publication
(10) Pub. No.: US 2026/0122576 A1
(43) Pub. Date: Apr. 30, 2026

(54) METHOD FOR DETERMINING RECEIVER PARAMETER, ZERO-POWER DEVICE, AND NETWORK DEVICE

(71) Applicant: GUANGDONG OPPO MOBILE TELECOMMUNICATIONS CORP., LTD., Dongguan (CN)

(72) Inventor: Weijie XU, Dongguan (CN)

(21) Appl. No.: 19/433,552

(22) Filed: Dec. 26, 2025

Related U.S. Application Data
(63) Continuation of application No. PCT/CN2023/113403, filed on Aug. 16, 2023.

(51) Int. Cl. H04W 52/02

(52) U.S. Cl. CPC H04W 52/0235

(57) ABSTRACT

The present disclosure discloses a method for determining a receiver parameter, a zero-power device, and a network device. The method is performed by a zero-power device, and the method includes the following. A receiver parameter to be used by the zero-power device is determined, where the receiver parameter includes a receiver type and/or a receiving bandwidth.

### CROSS-REFERENCE TO RELATED APPLICATION(S)

This application is a continuation of International Application No. PCT/CN2023/113403, filed Aug. 16, 2023, the entire disclosure of which is hereby incorporated by reference.

### TECHNICAL FIELD

This disclosure relates to the field of zero power, in particular to a method for determining a receiver parameter, a zero-power device, and a network device.

### BACKGROUND

With the continuous evolution of wireless communication technology, internet of things (IoT) technology has been applied to various aspects of production and daily life. Due to different requirements for power, size, and other factors in different scenarios, ultra-low-power, ultra-small, and battery-free zero-power IoT has emerged.

In zero-power IoT, a zero-power device may have a varying requirement for a receiver in a different communication scenario or process.

### SUMMARY

The present disclosure provides a method for determining a receiver parameter, a zero-power device, and a network device.

According to an aspect of embodiments of the present disclosure, a method for determining a receiver parameter is provided. The method is performed by a zero-power device, and the method includes the following. A receiver parameter to be used by the zero-power device is determined, where the receiver parameter includes a receiver type and/or a receiving bandwidth.

According to another aspect of embodiments of the present disclosure, a zero-power device is provided. The zero-power device includes a processor and a memory storing executable instructions which, when executed by the processor, causes the zero-power device to determine a receiver parameter to be used by the zero-power device, where the receiver parameter includes a receiver type and/or a receiving bandwidth.

According to another aspect of embodiments of the present disclosure, a network device is provided. The network device includes a processor and a memory storing executable instructions which, when executed by the processor, causes the network device to determine a receiver parameter to be used by a zero-power device, where the receiver parameter includes a receiver type and/or a receiving bandwidth.

Other features and aspects of the disclosed features will become apparent from the following detailed description, taken in conjunction with the accompanying drawings, which illustrate, by way of example, the features in accordance with embodiments of the disclosure.

The summary is not intended to limit the scope of any embodiment described herein.

### BRIEF DESCRIPTION OF THE DRAWINGS

To more clearly illustrate technical solutions in embodiments of the present disclosure, the following will give a brief introduction to the accompanying drawings used for illustrating embodiments. Apparently, the accompanying drawings illustrated below are some embodiments of the present disclosure. Based on these drawings, those of ordinary skill in the art may also obtain other drawings without creative effort.

FIG. 1 is a schematic diagram illustrating a zero-power communication system provided in an exemplary embodiment of the present disclosure.

FIG. 2 is a schematic diagram illustrating radio frequency (RF) power harvesting provided in the related art.

FIG. 3 is a schematic diagram illustrating a backscatter communication process provided in the related art.

FIG. 4 is a schematic diagram illustrating resistance-based load modulation provided in the related art.

FIG. 5 is a schematic diagram illustrating coding schemes provided in the related art.

FIG. 6 is a schematic diagram illustrating receiver architectures provided in the related art.

FIG. 7 is a flowchart illustrating a method for determining a receiver parameter provided in an exemplary embodiment of the present disclosure.

FIG. 8 is a flowchart of a method for determining a receiver parameter provided in an exemplary embodiment of the present disclosure.

FIG. 9 is a schematic diagram illustrating a receiving bandwidth provided in an exemplary embodiment of the present disclosure.

FIG. 10 is a schematic diagram illustrating a method for channel splitting provided in an exemplary embodiment of the present disclosure.

FIG. 11 is a flowchart of a method for information transmission provided in an exemplary embodiment of the present disclosure.

FIG. 12 is a flowchart of a method for determining a receiver parameter provided in an exemplary embodiment of the present disclosure.

FIG. 13 is a schematic diagram illustrating a method for signal transmission provided in an exemplary embodiment of the present disclosure.

FIG. 14 is a flowchart of a method for information transmission provided in an exemplary embodiment of the present disclosure.

FIG. 15 is a flowchart of a method for information transmission provided in an exemplary embodiment of the present disclosure.

FIG. 16 is a block diagram of a zero-power apparatus provided in an exemplary embodiment of the present disclosure.

FIG. 17 is a block diagram of a zero-power apparatus provided in an exemplary embodiment of the present disclosure.

FIG. 18 is a block diagram of a network-side apparatus provided in an exemplary embodiment of the present disclosure.

FIG. 19 is a block diagram of a network-side apparatus provided in an exemplary embodiment of the present disclosure.

FIG. 20 is a block diagram of a network-side apparatus provided in an exemplary embodiment of the present disclosure.

FIG. 21 is a schematic structural diagram of a zero-power device or a network device provided in an exemplary embodiment of the present disclosure.

### DETAILED DESCRIPTION

In order to make purposes, technical solutions, and advantages of the present disclosure clearer, the following will give a further elaboration of embodiments of the present disclosure with reference to the accompanying drawings. Exemplary embodiments will be elaborated in detail herein, and examples of these embodiments are illustrated in the accompanying drawings. When the following elaborations relate to the accompanying drawings, unless otherwise stated, the same numerals in different accompanying drawings refer to the same or similar elements. The implementations elaborated in the following exemplary embodiments are not intended to represent all implementations consistent with embodiments of the present disclosure. Instead, they are merely examples of methods and apparatuses consistent with some aspects of the present disclosure as elaborated in the appended claims.

The terms used in the present disclosure are merely intended for illustrating the embodiments, rather than limiting embodiments of the present disclosure. The singular form “a/an”, “said”, “above”, and “the” used in the present disclosure and the appended claims are also intended to include multiple forms, unless specified otherwise in the context. It may also be understood that, the term “and/or” used herein refers to and encompasses any or all possible combinations of one or more associated listed items.

It may be understood that, although the terms first, second, third, etc., may be used in the present disclosure to illustrate various information, such information shall not be limited to these terms. These terms are only used to distinguish one type of information from another. For example, first information may be referred to as second information, and similarly, second information may be referred to as first information, without departing from the scope of the present disclosure. The word “if” used herein may be interpreted as “when”, “in the case where”, or “in response to determining”, depending on the context.

The technical solutions elaborated in some embodiments of the present disclosure are applicable to various communication systems, such as: a global system of mobile communication (GSM), a code division multiple access (CDMA) system, a wideband code division multiple access (WCDMA) system, a general packet radio service (GPRS), a long term evolution (LTE) system, an advanced LTE (LTE-A) system, a new radio (NR) system, an evolved system of an NR system, an LTE-based access to unlicensed spectrum (LTE-U) system, an NR-based access to unlicensed spectrum (NR-U) system, a non-terrestrial network (NTN) system, a universal mobile telecommunication system (UMTS), a wireless local area network (WLAN), a wireless fidelity (WiFi), a 5th-Generation (5G) system, a cellular internet of things (IoT) system, a cellular passive IoT system, or other communication systems, and may also applicable to a future evolved system of the 5G NR system or a future evolved system of a 6th-Generation (6G) NR system.

It may be understood that, in some embodiments of the present disclosure, “5G” may also be referred to as “5G NR”or “NR”.

It may be understood that, in the elaboration of embodiments of the present disclosure, the term “correspondence” may mean that there is a direct or indirect correspondence between the two, may mean that there is an association between the two, or may mean a relationship of indicating and indicated or configuring and configured, etc.

In embodiments of the present disclosure, “pre-defined” herein can be implemented by pre-saving a corresponding code or table in a device (e.g., including the terminal device and the network device) or in other manners that can be used for indicating related information, and the present disclosure is not limited in this regard. For example, the “pre-defined” may mean defined in a protocol.

In embodiments of the present disclosure, “protocol” may refer to a communication standard protocol, which may include, for example, an LTE protocol, an NR protocol, and a related protocol applied to a future communication system, which is not limited in the present disclosure.

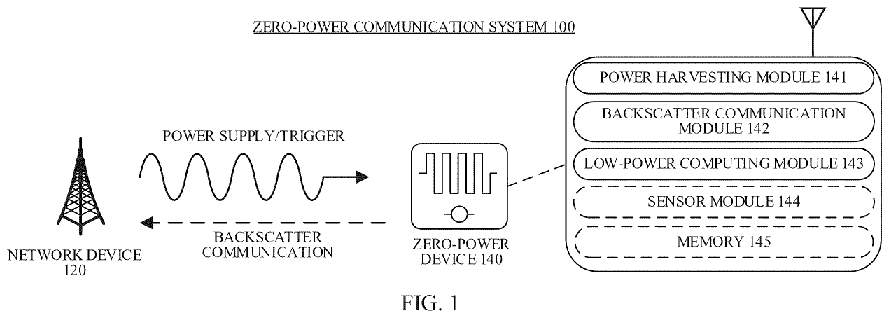

FIG. 1 illustrates a schematic diagram of a zero-power communication system 100 provided in an exemplary embodiment of the present disclosure. The zero-power communication system 100 includes a network device 120 and a zero-power device 140.

The network device 120 is configured to transmit a wireless power-supply signal and a downlink (DL) communication signal to the zero-power device 140 and receive a backscattered signal from the zero-power device 140. The zero-power device 140, also referred to as “ambient power enabled internet of things (ambient IoT) device, includes a power harvesting module 141, a backscatter communication module 142, and a low-power computing module 143. The power harvesting module 141 can harvest energy carried in a radio wave in space, to drive the low-power computing module 143 in the zero-power device 140 and realize backscatter communication. After obtaining energy, the zero-power device 140 can receive a control command from the network device 120 and transmit data to the network device 120 through backscattering based on control signaling. The data transmitted may be data stored in the zero-power device 140 itself (e.g., an identity identifier or pre-written information, such as the date, brand, and manufacturer of a product).

The zero-power device 140 may further include a sensor module 144 and a memory 145. The sensor module 144 may include various sensors. The zero-power device 140 can report data collected by the various sensors based on zero-power mechanisms. The memory 145 is configured to store some basic information (such as object identity, etc. ,) or obtain sensor data such as ambient temperature and ambient humidity.

The zero-power device 140 does not need any battery, and the low-power computing module 143 is configured to perform simple operations such as signal demodulation, decoding or encoding, or modulation. Therefore, the zero-power module requires only minimal hardware design, making a zero-power device 140 very low-cost and small in size.

The network device 120 includes, but is not limited to: a cellular network device such as 5G/6G network device and a base station device, and a WiFi/WLAN network device such as an access point (AP), a router, and a mobile AP, etc., where the mobile AP may be a mobile phone.

The zero-power device 140 includes, but is not limited to: a handheld device, a wearable device, an in-vehicle device, an IoT device, etc. The zero-power device 140 may be at least one of: a mobile phone, a tablet, an e-book reader, a laptop, a desktop computer, a television, a game console, an augmented reality (AR) terminal, a virtual reality (VR) terminal, a mixed reality (MR) terminal, a wearable device, a handle, an electronic tag, a controller, etc.

Key technologies for zero-power communication will be elaborated below.

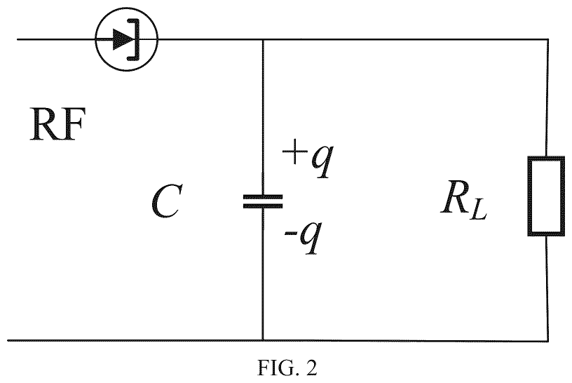

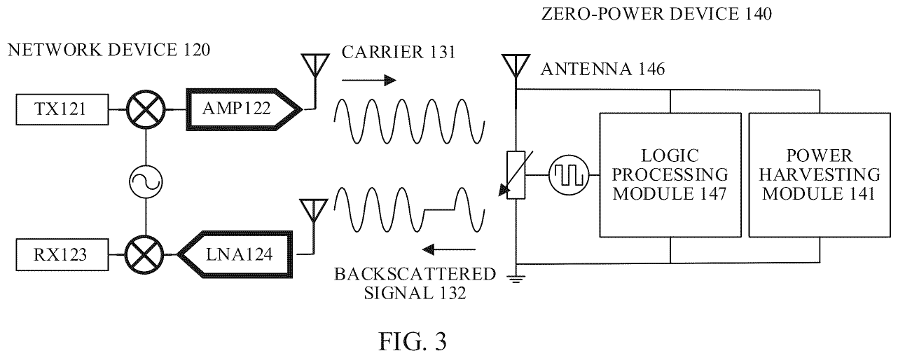

Radio Frequency (RF) Power Harvesting FIG. 2 is a schematic diagram illustrating RF power harvesting provided in the related art. The RF power harvesting is based on the principle of electromagnetic induction. An RF module performs electromagnetic induction and is connected to a capacitor C and a load resistor RL that are connected in parallel, to harvest power of a spatial electromagnetic wave and obtain power for driving a zero-power device, for example, driving a low-power demodulation, a modulation module(s), a sensor(s), and reading a memory(s), etc. Therefore, a conventional battery is not needed for the zero-power device.
Backscatter Communication FIG. 3 is a schematic diagram illustrating a backscatter communication process provided in the related art. A zero-power device 140 receives a wireless signal carrier 131 sent by a transmit (TX) module 121 of a network device 120 by using an amplifier (AMP) 122, modulates the wireless signal carrier 131, loads information to be sent by using a logic processing module 147, and harvests the RF power by using a power harvesting module 141. The zero-power device 140 radiates a modulated reflected signal 132 by using an antenna 146. This information transmission process is referred to as “backscatter communication”. A receive (RX) module 123 of the network device 120 receives the modulated reflected signal 132 by using a low noise amplifier (LNA) 124. Backscattering and load modulation function are inseparable. Load modulation adjusts and controls circuit parameters of an oscillation loop of the zero-power device 140 according to the beat of a data stream, such that a parameter, such as the impedance of an electronic tag, is changed accordingly, to implement a modulation process.

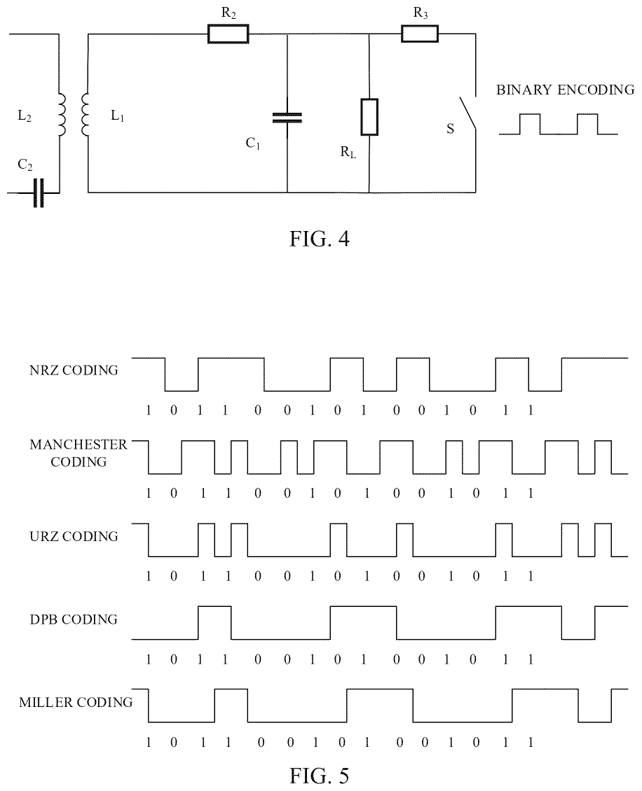

The load modulation technology mainly includes resistance-based load modulation and capacitor-based load modulation. FIG. 4 is a schematic diagram illustrating resistance-based load modulation provided in the related art. In resistance-based load modulation, a load resistor R_{L} is connected in parallel with a third resistor R₃, and they are switched on or off under the control of a switch S that is controlled based on a binary data stream. The on/off of the third resistor R₃ may cause a voltage change in the circuit. The load resistor R_{L} and a first capacitor C₁ are connected in parallel, the load resistor R_{L} and a second resistor R₂ are connected in series, and the second resistor R₂ and a first inductor L₁ are connected in series. The first inductor L₁ and a second inductor L₂ are coupled to each other, and the second inductor L₂ and a second capacitor C₂ are connected in series. Amplitude shift keying (ASK) modulation can be implemented, i.e., implementing signal modulation and transmission by adjusting the amplitude of a backscattered signal from the zero-power terminal. Similarly, in capacitor-based load modulation, a resonant frequency of the circuit may be changed through the on/off of the capacitor, to implement frequency shift keying (FSK), i.e., the signal can be modulated and transmitted by adjusting an operating frequency of the backscattered signal from the zero-power device.

The zero-power device performs information modulation on an incoming wave signal by means of load modulation, thereby achieving the backscatter communication process. Therefore, the zero-power device has the following significant advantages: there is no need to actively transmit a signal, and therefore, a complex RF circuit, such as a power amplifier (PA), an RF filter, etc., is not required; there is no need to actively generate a high-frequency (HF) signal, and therefore, an HF crystal oscillator is not required; and by means of backscatter communication, signal transmission is not required to consume energy of the zero-power device.

### Ultra-Low-Power Active Transmission Technology

A zero-power device may also use an ultra-low-power active transmission technology. Unlike backscattering, when the zero-power device performs data transmission by using the ultra-low-power active transmission technology, the zero-power device requires a relatively simple and low-power oscillator to generate an RF carrier, and modulates information to be sent on the RF carrier. Based on current research, the power consumption of an ultra-low-power active transmitter can be as low as several hundred microwatts, thereby achieving ultra-low-power data transmission.

Coding schemes for zero-power communication will be elaborated below.

FIG. 5 is a schematic diagram illustrating coding schemes provided in the related art. For data to be transmitted by an electronic tag, binary “1” and binary “0” may be represented in different forms of code. In a radio-frequency identity (RFID) system, one of the following coding schemes is usually adopted: non-return to zero (NRZ) coding, Manchester coding, unipolar return to zero (URZ) coding, differential binary phase (DBP) coding, Miller coding, differential coding, etc. Simply put, different pulse signals are adopted to represent binary 0 and binary 1.
NRZ coding: in NRZ coding, a high level represents binary “1”, and a low level represents binary “0”. NRZ coding in FIG. 5 is a schematic level diagram illustrating binary data 101100101001011 coded by using the NRZ coding.
Manchester coding: Manchester coding is also referred to as split-phase coding. In Manchester coding, a binary value is represented by a transition (rising or falling) of a level at half a bit period in a bit length. A negative transition at half the bit period represents the binary “1”, and a positive transition at half the bit period represents the binary “0”. An error of data transmission means that when data bits sent simultaneously by multiple electronic tags have different values, a received rising edge and falling edge cancel each other out, resulting in an uninterrupted carrier signal in the whole bit length. Manchester coding is impossible to remain unchanged in the bit length. According to the error, a reader/writer can determine the specific location where a collision occurs. Manchester coding is beneficial for finding errors in data transmission. When load modulation or backscatter modulation of a carrier is used, Manchester coding is usually used for data transmission from the electronic tag to the reader/writer.

Manchester coding in FIG. 5 is a schematic level diagram illustrating binary data 101100101001011 coded by using the Manchester coding.
URZ coding: in URZ coding, a high level in the first half of the bit period represents the binary “1”, and a low level signal maintained in the whole bit period represents the binary “0”. URZ coding in FIG. 5 is a schematic level diagram illustrating binary data 101100101001011 coded by using the URZ coding.
DPB coding: in DPB coding, any edge at half the bit period represents the binary “0”, and the case of no edge represents the binary “1”. Additionally, at the beginning of each bit period, the level is inverted. For a receiver, bit beats are easy to reconstruct. DPB coding in FIG. 5 is a schematic level diagram illustrating binary data 101100101001011 coded by using the DPB coding.
Miller coding: in Miller coding, any edge at half the bit period represents the binary “1”, and an unchanged level when entering the next bit period represents the binary “0”. The level changes at the beginning of a bit period. For a receiver, bit beats are easy to reconstruct. Miller coding in FIG. 5 is a schematic level diagram illustrating binary data 101100101001011 coded by using the Miller coding.
Differential coding: in differential coding, every binary “1” to be transmitted causes transitions in a signal level, and the signal level remains unchanged for the binary “0”.

The classification of zero-power devices will be elaborated below.

A zero-power device may be classified into the following types based on power sources and usage of the zero-power device.

### Passive Zero-Power Device

For a zero-power device, a built-in battery is not needed. When a zero-power device moves close to a network device, the zero-power device is within a near-field of the antenna radiation of the network device. Exemplarily, the network device is a reader/writer of the RFID system. Therefore, an antenna(s) of the zero-power device generates an induced current through electromagnetic induction. The induced current drives a low-power chip circuit of the zero-power device to perform demodulation of a forward-link signal and modulation of a reverse-link signal. For a backscatter link, the zero-power device performs signal transmission through backscattering or ultra-low-power active transmission. The passive zero-power device does not need a built-in battery to drive either the forward link or the reverse link, and therefore is truly a zero-power device. The passive zero-power device does not need a battery and has a simple RF circuit and a simple baseband circuit. For example, the passive zero-power device does not need components such as a low-noise amplifier (LNA), a PA, a crystal oscillator, an analog-to-digital converter (ADC), etc., and thus has advantages such as small size, light weight, low price, long service life, etc.

### Semi-Passive Zero-Power Device

A semi-passive zero-power device is not equipped with a conventional battery, but can use an RF power harvesting module to harvest radio wave energy, and store the harvested energy in a power storage unit. Exemplarily, the power storage unit is a capacitor. After the power storage unit obtains energy, a low-power chip circuit of the zero-power device can be driven to perform demodulation of a forward-link signal and modulation of a reverse-link signal. For a backscatter link, the zero-power device performs signal transmission through backscattering or ultra-low-power active transmission.

The semi-passive zero-power device does not need a built-in battery to drive either the forward link or the reverse link. The semi-passive zero-power device utilizes energy stored in a capacitor during operation, and the energy comes from radio wave energy harvested by the RF power harvesting module, and thus the semi-passive zero-power device is truly a zero-power device. The semi-passive zero-power device inherits many advantages of a passive zero-power device, and thus has advantages such as small size, light weight, low price, long service life, etc.

### Active Zero-Power Device

A zero-power device applied in some scenarios may also be referred to as an active zero-power device, and such a device can have a built-in battery. The battery is used to drive a low-power chip circuit of the zero-power device to perform demodulation of a forward-link signal and modulation of a reverse-link signal. However, for a backscatter link, the zero-power device performs signal transmission through backscattering or ultra-low-power active transmission. Therefore, the zero-power consumption of the active zero-power device mainly lies in that signal transmission on the reverse link does not require the power of the device itself but is based on backscattering. In the active zero-power device, the built-in battery powers an RFID chip, thereby increasing the distance of a tag for reading and writing, and improving the reliability of communication. Therefore, the active zero-power device is applicable in some scenarios with relatively high requirements on communication distance, reading delay, and other aspects.

The classification of zero-power devices will be elaborated below based on a transmitter type.

(1) Backscatter-Based Zero-Power Device Such a zero-power device performs uplink data transmission through backscattering. The zero-power device does not have an active transmitter for active transmission, but has only a backscattering transmitter. Therefore, if data transmission is to be performed, the zero-power device needs to be provided with a carrier wave from the network device, and then performs backscattering based on the carrier wave, thereby implementing data transmission.
(2) Active Transmitter-Based Zero-Power Device Such a zero-power device performs uplink data transmission by using an active transmitter capable of active transmission. Therefore, when performing data transmission, the zero-power device can transmit data by using the active transmitter of the zero-power device itself without requiring the network device to provide a carrier wave. An active transmitter applicable to the zero-power device may be, for example, an ultra-low-power ASK transmitter, an ultra-low-power FSK transmitter, etc. Based on current achievement, for the case of transmitting a signal of 100 microwatts (μw) by such a transmitter, overall power consumption can be decreased to 400˜600 μw.

### (3) Zero-Power Device Having Both a Backscattering Transmitter and an Active Transmitter

Such a device can support both a backscattering transmitter and an active transmitter. The zero-power device can determine, according to different conditions (such as electric quantity and available ambient power source) or based on scheduling by a network device, whether to use a backscattering transmitter or an active transmitter for active transmission.

Cellular IoT will be Elaborated Below

Cellular IoT is booming, for example, the 3GPP has standardized narrowband internet of things (NB-IoT), machine-type communications (MTC), reduced capability (RedCap), and other IoT technologies. However, IoT communication requirements remain unmet in many scenarios as follows.

### Harsh Communication Environments

In some IoT scenarios, extreme environments such as high temperature, extremely low temperature, high humidity, high pressure, high radiation, or high-speed motion may be encountered. Examples include ultra-high voltage substations, high-speed train tracks, cold regions, industrial production lines, etc. In these scenarios, due to limitations of the operating environment of conventional power supplies, existing IoT terminal devices cannot operate.

Moreover, extreme environments are also unfavorable for IoT maintenance, such as battery replacement.

### Extremely Small Terminal Form Requirements

Some IoT communication scenarios, such as food traceability, goods circulation, and smart wearables, require terminals to be extremely small in size for convenient use in such scenarios. For example, IoT terminal devices used for goods management in circulation are often implemented as electronic tags, which are embedded in product packaging in a very compact form. Another example is lightweight wearable devices, which can improve the user experience while meeting user needs.

### Extremely Low-Cost IoT Communication Requirements

Many IoT communication scenarios require a sufficiently low cost of an IoT terminal device to improve competitiveness compared with other alternative technologies. For example, in logistics or warehousing scenarios, to facilitate the management of a large number of circulating items, the IoT terminal device can be attached to each item, and communication between the IoT terminal device and the logistics network can achieve precise management throughout the entire logistics process and life cycle. These scenarios require the price of the IoT terminal device to be sufficiently competitive.

Therefore, to cover these unmet IoT communication requirements, the cellular network also needs to develop ultra-low-cost, ultra-small, battery-free/maintenance-free IoT, and a zero-power IoT can precisely meet this demand.

The zero-power IoT may also be referred to as “ambient IoT” or “passive IoT”. An ambient IoT device refers to an IoT device that drives itself by utilizing various ambient energy, such as RF energy, light energy, solar energy, thermal energy, mechanical energy, etc. The ambient IoT device may have no energy storage capability, or may have very limited energy storage capability (such as use of a capacitor with a capacity of tens of microfarads (μF)).

Compared to existing IoT devices, the ambient IoT device has numerous advantages, such as no need for regular batteries, maintenance-free, compact size, low complexity and cost, long service life, etc.

The zero-power IoT may be at least used in the following four types of scenarios: (1) object recognition, such as logistics, management of products in a product line, and management of a supply chain; (2) environmental monitoring, such as monitoring of working environment, temperature and humidity of natural environment, and toxic gases; (3) positioning, such as indoor positioning, intelligent object search, and positioning of products in a product line; (4) intelligent control, such as intelligent control of various electrical appliances (switching on/off of an air conditioner and temperature adjustment) in a smart home, and intelligent control of various facilities (automatic pouring and fertilization) in an agricultural greenhouse.

A receiver architecture for zero-power communication will be elaborated below.

FIG. 6 is a schematic diagram illustrating receiver architectures provided in the related art. FIG. (a) illustrates an RF-based ultra-low-power receiver architecture (referred to as “RF-based receiver architecture” for short). FIG. (b) illustrates an intermediate frequency (IF)-based ultra-low-power receiver architecture (referred to as “IF-based receiver architecture” for short). FIG. (c) illustrates a zero IF-based ultra-low-power receiver architecture (referred to as “zero IF-based receiver architecture”for short).

In an RF-based receiver architecture, an RF signal (referred to as “RF” for short) is processed through a matching network, an RF bandpass filter (BPF), an RF LNA, an RF envelope detector, a baseband amplifier (BB AMP), a BB low-pass filter (LPF), a 1-bit or multi-bit ADC, and then digital BB processing.

In an IF-based receiver architecture, an RF signal is processed through a matching network, an RF BPF, an RF LNA, a local oscillator (LO), a mixer, an IF AMP, an IF BPF, an IF envelope detector, a BB AMP, a BB LPF, a 1-bit or multi-bit ADC, and then digital BB processing.

In a zero IF-based receiver architecture, an RF signal is processed through a matching network, an RF BPF, an RF LNA, an LO, a mixer, a BB AMP, a BB LPF or a BB BPF, a 1-bit or multi-bit ADC, and then digital BB processing.

Among these three receiver architectures, in the RF-based receiver architecture, a target signal to be received within a bandwidth range is obtained by using the RF BPF, and then is processed through envelope detection and subsequent baseband processing. Such an architecture has the simplest structure and the lowest power consumption, which can be as low as a few microwatts or even lower. However, due to the relatively poor precision of the RF BPF, even when the target signal occupies a relatively narrow bandwidth, a receiver with such an architecture always requires a relatively wide receiving bandwidth. As a result, more noise and interference are introduced during reception, leading to relatively poor receiver performance, or in other words, relatively low sensitivity.

In the IF-based receiver architecture or the zero IF-based receiver architecture, during signal reception, in addition to obtaining a target signal to be received within a bandwidth range by using the RF BPF, an RF signal is further down-converted, and a baseband signal is further filtered by using the LPF to eliminate noise and interference. As a result, the receiver has a narrow receiving bandwidth and high receiver performance (sensitivity). However, a receiver with any one of these two architectures requires an LO that consumes power of up to 100 μw or more. Therefore, the power consumption of the receiver with any one of these two architectures is relatively high. Nevertheless, the receiver is still suitable for a zero-power device due to its very low absolute power consumption.

In some embodiments, the RF-based receiver adopts an RF-based receiver architecture, and directly performs detection on an RF without requiring frequency conversion.

The IF-based receiver adopts an IF-based receiver architecture. An RF is an HF signal with a center frequency in a first range. The IF-based receiver down-converts the RF to obtain an IF signal with a center frequency in a second range. The minimum value of the first range exceeds the maximum value of the second range. Exemplarily, the HF signal is a signal with a center frequency of 900 MHz or a signal with a center frequency of 1.8 GHz, and the IF signal is a signal with a center frequency in the range of 10 MHz to 20 MHz.

The zero IF-based receiver adopts a zero IF-based receiver architecture. An RF is an HF signal with a center frequency in a first range. The zero IF-based receiver down-converts the RF to obtain a signal with a center frequency of zero. The minimum value of the first range exceeds zero.

With the continuous evolution of wireless communication technology, IoT technology has been applied to various aspects of production and daily life. Due to different requirements for power, size, and other factors in different scenarios, ultra-low-power, ultra-small, and battery-free zero-power IoT has emerged. In zero-power IoT, a zero-power device may have a varying requirement for a receiver in a different communication scenario or process. For example, in smart home scenarios, the demand for zero-power devices is limited, requiring only a few to several dozen. Therefore, a zero-power device with lower power and longer usage time is more suitable. For example, a zero-power device with an RF-based receiver is used. The RF-based receiver adopts an ultra-low-power RF-based receiver architecture.

In industrial intelligent scenarios, a larger number of zero-power devices are required. Therefore, a zero-power device with relatively high transmission efficiency is more suitable. For example, a zero-power device with an IF-based receiver or a zero IF-based receiver is used. The IF-based receiver adopts an IF-based ultra-low-power receiver architecture. The zero IF-based receiver adopts a zero IF-based ultra-low power receiver. These two types of receivers can receive signals by using relatively narrow receiving bandwidths. Therefore, more zero-power devices can be supported to perform communication within the same frequency band, thus achieving relatively high transmission efficiency.

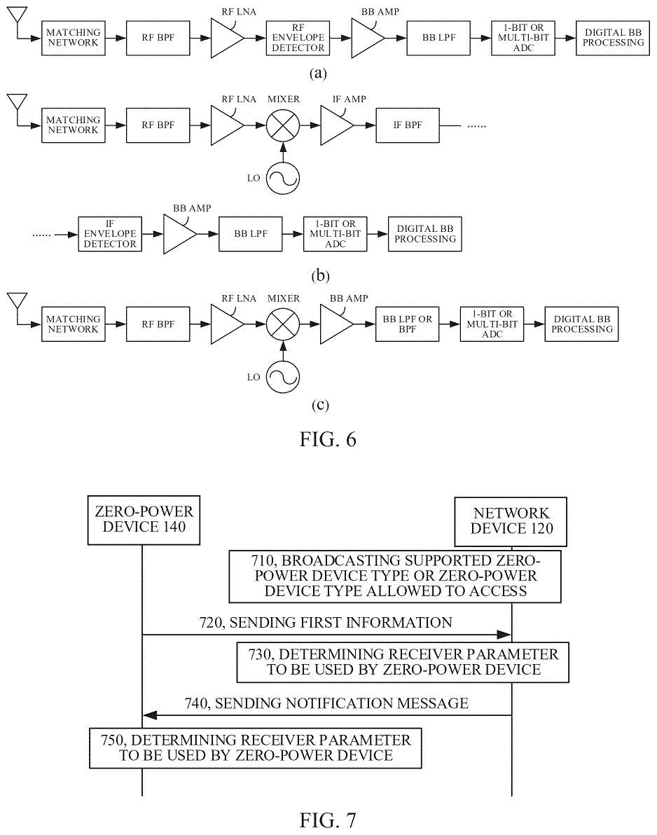

However, in different communication scenarios or processes, the zero-power device needs to use a corresponding receiver for signal transmission. To address the above issue, a method for determining a receiver parameter is provided in embodiments of the present disclosure. FIG. 7 is a flowchart illustrating a method for determining a receiver parameter provided in an exemplary embodiment of the present disclosure. The method is executed by a zero-power device 140 and a network device 120, and the method includes the following.

At S710, the network device 120 broadcasts a supported zero-power device type or a zero-power device type allowed to access the network device 120.

In some embodiments, the supported zero-power device type or the zero-power device type allowed to access is determined by the network device 120 based on a communication scenario (referred to as “scenario”for short).

Based on factors such as communication scenarios, performance requirements, and signal coverage, etc., the network device 120 determines the supported zero-power device type or the zero-power device type allowed to access.

Scenario 1: in scenarios such as smart homes and wearable devices, the demand for the number of zero-power devices 140 is relatively low, and users focus more on the user experience. For example, the zero-power device 140 can be powered in a short time, such that the zero-power device 140 can perform functions such as communication or positioning. When a supported receiver is an RF-based receiver, due to its lower power consumption, power supply can be achieved in a shorter time. For example, when a mobile phone is used to wirelessly power the zero-power device 140, an application generally needs to be started to trigger the mobile phone to wirelessly power the zero-power device 140 during communication with the zero-power device 140. If the zero-power device 140 consumes less power during operation, the time of power supply by the mobile phone can be reduced, thereby reducing the energy consumption of the mobile phone.

On the other hand, although the RF-based receiver has low sensitivity and low transmission efficiency, a sensitivity range of −20 dB to −35 dB is already a current implementation limit for wireless power supply, and the RF-based receiver can achieve a sensitivity range of −35 dB to −50 dB. Additionally, in scenarios such as smart homes where the demand for the number of zero-power devices 140 is relatively low, the relatively low transmission efficiency does not affect the user experience.

Scenario 2: in scenarios such as industrial intelligence or smart control, a large number of zero-power devices 140 are required for environmental monitoring, production line monitoring, and asset inventory. Given the large number of zero-power devices 140 in such scenarios, it is essential to provide a relatively high throughput to facilitate communication with the zero-power devices 140. For these scenarios, the zero-power device 140 supports an IF-based receiver or a zero IF-based receiver. These two types of receivers have high sensitivity and can receive signals by using relatively narrow receiving bandwidths. As a result, more zero-power devices 140 can be supported to perform communication within the same frequency band, thus achieving relatively high transmission efficiency.

Scenario 3: in some scenarios, the required number of zero-power devices 140 varies. For example, in a warehouse scenario, a large number of zero-power devices 140 are required, but when items are delivered from a warehouse to a supermarket, fewer zero-power devices 140 are required. Therefore, for such scenarios, the zero-power device 140 supports two types of receivers: an RF-based receiver and an IF (zero IF)-based receiver. The network device 120 can notify the zero-power device 140 to use the appropriate receiver based on the specific scenario.

In some embodiments, the supported zero-power device type or the zero-power device type allowed to access is broadcast by sending a broadcast signal or a beacon frame signal.

Based on the supported zero-power device type or the zero-power device type allowed to access that is broadcast by the network device 120, only a zero-power device 140 corresponding to the zero-power device type can access the network device 120, or the zero-power device 140 may adjust its used receiver to match the zero-power device type supported by the network device 120 or the zero-power device type allowed to access the network device 120.

At S720, the zero-power device 140 sends first information.

The first information includes receiver capability information of the zero-power device 140 or receiver parameter information of the zero-power device 140.

In some embodiments, the receiver capability information or the receiver parameter information includes at least one of: first capability information and second capability information. The first capability information indicates a receiver type, the second capability information indicates a receiving bandwidth, and the receiving bandwidth indicates a bandwidth over which the receiver receives signals.

In some embodiments, the first capability information indicates a receiver type supported by the zero-power device 140, and the second capability information indicates a bandwidth for signal reception.

In some embodiments, the first capability information includes at least one of: RF-based receiver information, IF-based receiver information, and zero IF-based receiver information.

In some embodiments, the zero-power device 140 supports any one of the above receivers, or supports both an RF-based receiver and an IF-based receiver, or supports both an RF-based receiver and a zero IF-based receiver, or supports all three types of receivers, or supports other types of receivers, which is not limited in embodiments of the present disclosure.

In some embodiments, the second capability information includes at least one of: a first bandwidth value, a second bandwidth value, a first multiple of a channel bandwidth, and a second multiple of a channel bandwidth. The first bandwidth value or the first multiple of a channel bandwidth indicates a receiving bandwidth corresponding to an RF-based receiver. The second bandwidth value or the second multiple of a channel bandwidth indicates a receiving bandwidth corresponding to an IF-based receiver or a zero IF-based receiver. The first bandwidth value is greater than the second bandwidth value. The first multiple is greater than the second multiple, and the first multiple and the second multiple each are a positive integer.

In some embodiments, a channel is determined based on a communication protocol and is used for sending a DL signal, and a channel bandwidth of the channel is determined based on a communication protocol. For example, one channel bandwidth is 250 kHz. Exemplarily, a receiving bandwidth of the RF-based receiver is 1000 kHz or four channel bandwidths, and a receiving bandwidth of the IF (zero IF)-based receiver is 250 kHz or one channel bandwidth.

In some embodiments, the operations at S720 are performed before the operations at S710, and an execution order of the operations at S710 and the operations at S720 is not limited in embodiments of the present disclosure. In the present disclosure, the operations at S710 are performed before the operations at S720 as an example.

At S730, the network device 120 determines a receiver parameter to be used by the zero-power device 140.

The receiver parameter includes a receiver type and/or a receiving bandwidth.

In some embodiments, the network device 120 determines the receiver type and/or the receiving bandwidth to be used by the zero-power device 140 based on the communication scenario. Exemplarily, in a smart home scenario, the network device 120 determines that the zero-power device 140 is to use an RF-based receiver, with the receiving bandwidth of four channel bandwidths.

At S740, the network device 120 sends a notification message.

In some embodiments, the zero-power device 140 supports at least two receivers, or the zero-power device 140 supports at least two types of receiver parameters. The notification message indicates the receiver parameter.

In some embodiments, the notification message is sent by the network device 140 based on a communication scenario.

In some embodiments, the notification message is a first notification message. The first notification message is used to notify the zero-power device 140 to use a first receiver parameter, where the first receiver parameter includes a first receiver type and/or a first receiving bandwidth.

In some embodiments, the first receiver type is an RF-based receiver type.

The first notification message is sent by the network device 120 in a communication scenario where the required number of zero-power devices 140 is less than a first threshold, where the first threshold is determined or predefined based on a communication protocol. For example, in a smart home scenario, the first notification message is sent to notify the zero-power device 140 to use an RF-based receiver, with the first receiving bandwidth of four channel bandwidths.

In some embodiments, the notification message is a second notification message. The second notification message is used to notify the zero-power device to use a second receiver parameter, where the second receiver parameter includes a second receiver type and/or a second receiving bandwidth.

In some embodiments, the second receiver type is an IF-based receiver type or a zero IF-based receiver type.

The second notification message is sent by the network device 120 in a communication scenario where the required number of zero-power devices 140 exceeds a second threshold, where the second threshold is determined or predefined based on a communication protocol. For example, in an industrial intelligent scenario, the second notification message is sent to notify zero-power device 140 to use an IF (zero IF)-based receiver, with the second receiving bandwidth of two channel bandwidths.

At S750, the zero-power device 140 determines a receiver parameter to be used by the zero-power device 140.

The receiver parameter includes a receiver type and/or a receiving bandwidth.

In some embodiments, the zero-power device 140 supports at least two receivers, or the zero-power device 140 supports at least two types of receiver parameters. The receiver parameter is determined based on a notification message sent by the network device 120.

In some embodiments, the notification message is sent by the network device 120 based on a communication scenario.

For specific implementation details, reference may be made to the operations at S740, which will not be repeated herein.

In some embodiments, the zero-power device 140 supports at least two receivers, or the zero-power device 140 supports at least two types of receiver parameters. The receiver parameter is determined based on a communication process.

The communication process includes processes such as cell search, beacon frame signal scan, data communication, etc.

In some embodiments, in the case where the communication process is a first communication process, it is determined that the zero-power device 140 is to use a first receiver parameter, where the first communication process includes a cell search process or a beacon frame signal scan process, and the first receiver parameter includes a first receiver type and/or a first receiving bandwidth.

Exemplarily, in the case where the communication process is cell search, it is determined that the zero-power device 140 is to use an RF-based receiver, with the first receiving bandwidth of four channel bandwidths.

In some embodiments, in the case where the communication process is a second communication process, it is determined that the zero-power device 140 is to use a second receiver parameter, where the second communication process includes a data communication process, and the second receiver parameter includes a second receiver type and/or a second receiving bandwidth.

Exemplarily, in the case where the communication process is data communication, it is determined that the zero-power device 140 is to use an IF (zero IF)-based receiver, with the second receiving bandwidth of two channel bandwidths.

In embodiments of the present disclosure, the operations at S710, S720, S730, and S740 are optional. In different embodiments, one or more of the operations may be omitted or substituted. For example, the operations at S710 are omitted, and execution may start with the operations at S720.

The operations at S720 and S750 may be implemented as an independent embodiment, the operations at S710, S720, and S750 may be implemented as an independent embodiment, the operations at S730, S740, and S750 may be implemented as an independent embodiment, the operations at S720, S730, S740, and S750 may be implemented as an independent embodiment, the operations at S710, S730, S740, and S750 may be implemented as an independent embodiment, which are not limited herein.

The operations at S710 may be implemented as an independent embodiment, for example, may be independently implemented as a method for broadcasting a zero-power device type.

The operations at S720 may be implemented as an independent embodiment, for example, may be independently implemented as a method for information transmission.

The operations at S730 may be implemented as an independent embodiment, for example, may be independently implemented as a method for determining a receiver parameter.

The operations at S740 may be implemented as an independent embodiment, for example, may be independently implemented as a method for information transmission.

The operations at S750 may be implemented as an independent embodiment, for example, may be independently implemented as a method for determining a receiver parameter.

In summary, in the method provided in embodiments of the present disclosure, the receiver parameter to be used by the zero-power device is determined, where the receiver parameter includes the receiver type and/or the receiving bandwidth, such that a receiver parameter corresponding to a different scenario can be determined to meet actual requirements, thereby enhancing the flexibility of the zero-power device.

In the method provided in embodiments of the present disclosure, the zero-power device uses an RF-based receiver, thereby reducing the energy consumption of the zero-power device.

In the method provided in embodiments of the present disclosure, the zero-power device uses an IF-based receiver or a zero IF-based receiver, thereby improving the transmission efficiency of the zero-power device.

In the method provided in embodiments of the present disclosure, the zero-power device sends the first information, where the first information includes the receiver capability information of the zero-power device or the receiver parameter information of the zero-power device, such that the receiver type and/or the receiving bandwidth to be used by the zero-power device can be determined.

In the method provided in embodiments of the present disclosure, the network device broadcasts the supported zero-power device type or the zero-power device type allowed to access, such that only a zero-power device corresponding to the zero-power device type can access the network device, or the zero-power device may adjust its used receiver to match the zero-power device type supported by the network device or the zero-power device type allowed to access the network device.

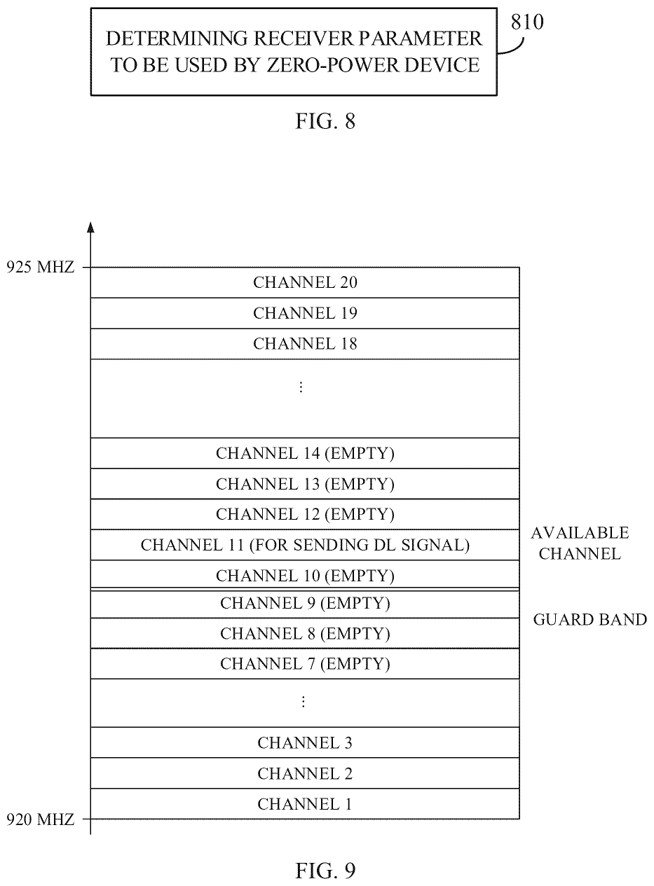

FIG. 8 is a flowchart of a method for determining a receiver parameter provided in an exemplary embodiment of the present disclosure. The method is performed by a zero-power device, and the method includes the following.

At S810, a receiver parameter to be used by the zero-power device is determined.

The receiver parameter includes a receiver type and/or a receiving bandwidth.

In some embodiments, the receiver type indicates a receiver architecture type to be used by the zero-power device, such as an RF-based receiver and an IF (zero IF)-based receiver. The receiving bandwidth indicates a bandwidth for signal reception.

In some embodiments, the zero-power device supports at least two receivers, or the zero-power device supports at least two types of receiver parameters. The receiver parameter is determined based on a notification message sent by a network device.

In some embodiments, the notification message is sent by the network device based on a communication scenario.

Exemplarily, the network device sends a first notification message in communication scenarios with a relatively low demand for the number of zero-power devices, such as a smart home scenario, and sends a second notification message in communication scenarios with a relatively high demand for the number of zero-power devices, such as an industrial intelligence scenario.

In some embodiments, the notification message is a first notification message. The first notification message is used to notify the zero-power device to use a first receiver parameter, where the first receiver parameter includes a first receiver type and/or a first receiving bandwidth.

In some embodiments, the first receiver type is an RF-based receiver type.

The first notification message is sent by the network device in a communication scenario where the required number of zero-power devices is less than a first threshold, where the first threshold is determined or predefined based on a communication protocol. For example, in the smart home scenario, the first notification message is sent to notify the zero-power device to use an RF-based receiver, with the first receiving bandwidth of four channel bandwidths.

In some embodiments, the notification message is a second notification message. The second notification message is used to notify the zero-power device to use a second receiver parameter, where the second receiver parameter includes a second receiver type and/or a second receiving bandwidth.

In some embodiments, the second receiver type is an IF-based receiver type or a zero IF-based receiver type.

The second notification message is sent by the network device in a communication scenario where the required number of zero-power devices exceeds a second threshold, where the second threshold is determined or predefined based on a communication protocol. For example, in the industrial intelligent scenario, the second notification message is sent to notify the zero-power device to use an IF (zero IF)-based receiver, with the second receiving bandwidth of two channel bandwidths.

In some embodiments, the zero-power device receives a DL signal sent by the network device in the case where the zero-power device uses the first receiver parameter.

A zero-power device using a different receiver type has a different requirement for the network, such as a different receiving bandwidth. When an RF-based receiver is used, the receiving bandwidth is relatively wide, for example, the receiving bandwidth is M channel bandwidths. When the channel bandwidth is 250 kHz and M=8, the receiving bandwidth is 2 MHz. As a result, when the network device sends a DL signal (e.g., the DL signal is sent within one channel, occupying a bandwidth of no more than 250 kHz), there can be no signal sent to another zero-power device within the 2 MHz receiving bandwidth of the zero-power device. In other words, within the 2 MHz receiving bandwidth, even though the DL signal sent by the network device occupies the bandwidth of no more than 250 kHz, the remaining bandwidth shall not be used to send a DL signal to another zero-power device or another device.

FIG. 9 is a schematic diagram of a receiving bandwidth provided in an exemplary embodiment of the present disclosure. The receiving bandwidth spans eight channel bandwidths, occupying Channel 7 to Channel 14. Channel 11 is an available channel for sending a DL signal, and the remaining seven channels serve as guard bands within which no other signal is sent. This is because a zero-power device typically employs relatively simple DL signal waveforms, and if another signal is sent within the bandwidth, the DL signal of the zero-power device may be interfered with and cannot be demodulated. However, an IF-based receiver or a zero IF-based receiver only requires a relatively narrow receiving bandwidth, such as a bandwidth of one channel or a bandwidth of N channels, where N=1, 2, or 3, and N<M.

In some embodiments, when the zero-power device supporting at least two receivers communicates with the network device, the method includes at least one of the following.

(1) The zero-power device sends receiver type information and/or receiving bandwidth information (e.g., a value of the receiving bandwidth, where the receiving bandwidth is a multiple of a channel bandwidth) to the network device.

In some embodiments, the zero-power device sends first information, where the first information includes receiver capability information of the zero-power device or receiver parameter information of the zero-power device.

In some embodiments, the receiver capability information or the receiver parameter information includes at least one of: first capability information, and second capability information, where the first capability information indicates a receiver type, and the second capability information indicates a receiving bandwidth.

In some embodiments, the first capability information indicates a receiver type supported by the zero-power device, and the second capability information indicates a bandwidth for signal reception.

In some embodiments, the first capability information includes at least one of: RF-based receiver information, IF-based receiver information, and zero IF-based receiver information.

In some embodiments, the zero-power device supports any one of the above receivers, or supports both an RF-based receiver and an IF-based receiver, or supports both an RF-based receiver and a zero IF-based receiver, or supports all three types of receivers, or supports other types of receivers, which is not limited in embodiments of the present disclosure.

In some embodiments, the second capability information includes at least one of: a first bandwidth value, a second bandwidth value, a first multiple of a channel bandwidth, and a second multiple of a channel bandwidth. The first bandwidth value or the first multiple of a channel bandwidth indicates a receiving bandwidth corresponding to an RF-based receiver. The second bandwidth value or the second multiple of a channel bandwidth indicates a receiving bandwidth corresponding to an IF-based receiver or a zero IF-based receiver. The first bandwidth value is greater than the second bandwidth value. The first multiple is greater than the second multiple, and the first multiple and the second multiple each are a positive integer.

In some embodiments, a channel is determined based on a communication protocol and is used for sending a DL signal, and a channel bandwidth of the channel is determined based on a communication protocol. For example, one channel bandwidth is 250 kHz. Exemplarily, a receiving bandwidth of the RF-based receiver is 1000 kHz or four channel bandwidths, and a receiving bandwidth of the IF (zero IF)-based receiver is 250 kHz or one channel bandwidth.

(2) Based on different communication scenarios, the network device only supports a zero-power device of a specified receiver type, and within the coverage of the network device, only the zero-power device of the specified receiver type is used.

In some embodiments, the network device broadcasts a supported zero-power device type or a zero-power device type allowed to access by sending a broadcast signal or a beacon frame signal.

Based on the supported zero-power device type or the zero-power device type allowed to access that is broadcast by the network device, only a zero-power device corresponding to the zero-power device type can access the network device, or the zero-power device may adjust its used receiver to match the zero-power device type supported by the network device or the zero-power device type allowed to access the network device.

In some embodiments, the zero-power device sends an uplink (UL) signal to the network device in response to receiving the DL signal.

In some embodiments, a bandwidth occupied for the UL signal is the same or different in the case where a different receiver parameter is used.

Exemplarily, for a zero-power device supporting an RF-based receiver, its receiving bandwidth is eight times the channel bandwidth, and the bandwidth occupied for the UL signal is one times the channel bandwidth. For a zero-power device supporting an IF-based receiver, its receiving bandwidth is one times the channel bandwidth, and the bandwidth occupied for the UL signal is also one times the channel bandwidth. That is, in the case where two receiver parameters are used, the bandwidth occupied for the UL signal is the same.

In some embodiments, the zero-power device supports at least two receivers, or the zero-power device supports at least two types of receiver parameters. The receiver parameter is determined based on a communication process.

The communication process includes processes such as cell search, beacon frame signal scan, data communication, etc.

In some embodiments, it is determined that the zero-power device is to use a first receiver parameter in the case where the communication process is a first communication process, where the first communication process includes a cell search process or a beacon frame signal scan process, and the first receiver parameter includes a first receiver type and/or a first receiving bandwidth.

Exemplarily, in the case where the communication process is cell search, it is determined that the zero-power device is to use an RF-based receiver, and the first receiving bandwidth is four channel bandwidths. Since cell search typically lasts for a period of time, using an RF-based receiver is conducive to saving power.

In some embodiments, it is determined that the zero-power device is to use a second receiver parameter in the case where the communication process is a second communication process, where the second communication process includes a data communication process, and the second receiver parameter includes a second receiver type and/or a second receiving bandwidth.

Exemplarily, in the case where the communication process is data communication, it is determined that the zero-power device is to use an IF (zero IF)-based receiver, and the second receiving bandwidth is two channel bandwidths. During data communication, using an IF (zero-IF)-based receiver can enhance transmission efficiency.

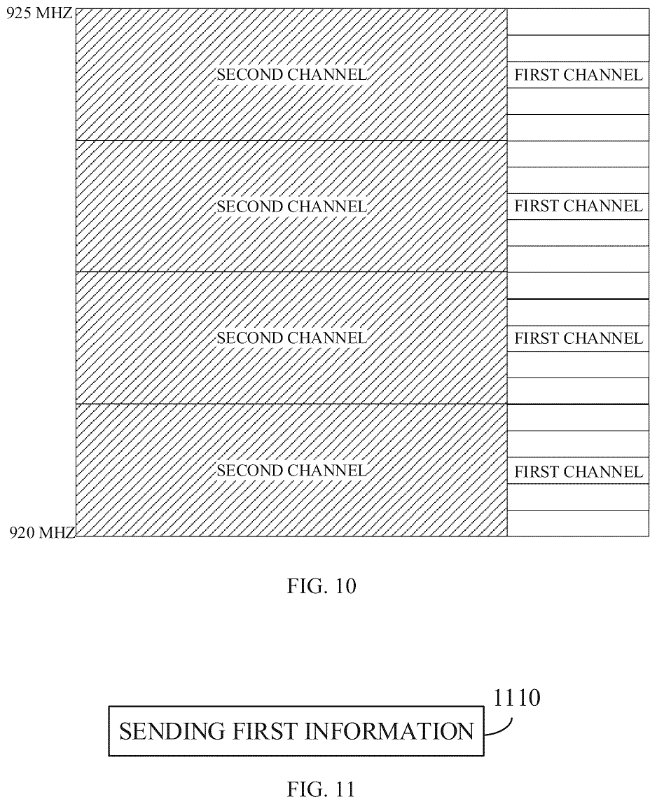

FIG. 10 is a schematic diagram illustrating a method for channel splitting provided in an exemplary embodiment of the present disclosure. Based on a communication protocol of a related region, a frequency band from 920 MHz to 925 MHz is split into 20 channels, and each channel occupies a bandwidth of 250 kHz. When a zero-power device is deployed within the frequency band, a transmission by both a network device and the zero-power device shall adhere to the method for channel splitting. To support a different receiver, a new method for splitting may be established based on this.

In some embodiments, a DL signal sent by the network device through one channel in a channel group is received in the case where the zero-power device uses the first receiver parameter, where the channel group contains at least two channels. Alternatively, a DL signal is received through a channel corresponding to the first receiving bandwidth in the case where the zero-power device uses the first receiver parameter.

In some embodiments, a bandwidth of the channel group is a first multiple of a channel bandwidth of the one channel, or a bandwidth of the channel corresponding to the first receiving bandwidth is a first multiple of the channel bandwidth of the one channel.

In some embodiments, the channel is determined based on a communication protocol and is used for sending a DL signal, and a channel bandwidth of the channel is determined based on a communication protocol.

Exemplarily, in a new method for splitting, a frequency band contains X channel groups, and each channel group contains M first channels, where the first channel is determined based on a communication protocol and is used for sending a DL signal, for example, X=4, M=5, and X may be either an odd or an even. In this case, a DL signal is sent according to a bandwidth of the channel group, where the bandwidth of the channel group is a first multiple of a channel bandwidth of the first channel.

Alternatively, the frequency band contains X second channels, where a channel bandwidth of the second channel is M times the channel bandwidth of the first channel, for example, X=4, M=5, and X may be either an odd or an even. In this case, a DL signal is sent according to the channel bandwidth of the second channel, where the channel bandwidth of the second channel is the first multiple of the channel bandwidth of the first channel.

In some embodiments, a DL signal is not sent through another channel other than the one channel in the channel group, or an occupancy signal is sent through another channel other than the one channel in the channel group.

When the network device sends a DL signal to the zero-power device, the DL signal is sent only through the first channel, and the DL signal is not sent or an occupancy signal is sent through another channel other than the first channel.

In some embodiments, the channel used for sending a DL signal is a most central channel in the channel group, or the channel used for sending a DL signal is one of two most central channels in the channel group.

In the case where the channel group contains an odd number of channels, the channel used for sending a DL signal is the most central channel in the channel group. In the case where the channel group contains an even number of channels, the channel used for sending a DL signal is one of the two most central channels in the channel group.

Exemplarily, the second channel contains five channels, and the first channel (used for sending a DL signal) is the most central channel (the third of the five channels). Alternatively, the second channel contains four channels, and the first channel is one of the two most central channels (the second or the third of the four channels).

When X=2, each second channel occupies a bandwidth of 2.5 MHz, each second channel contains M=10 first channels, and the network device may send a DL signal in the fifth channel or the sixth channel. Similarly, when X=1, M=20; and when X=5, M=4.

In some embodiments, a DL signal sent by the network device is received in the case where the zero-power device uses the second receiver parameter.

In some embodiments, a DL signal sent by the network device through one channel in a channel group is received in the case where the zero-power device uses the second receiver parameter, where the channel group contains at least one channel. Alternatively, a DL signal is received through a channel corresponding to the second receiving bandwidth in the case where the zero-power device uses the second receiver parameter.

In some embodiments, a bandwidth of the channel group is a second multiple of a channel bandwidth of the one channel, or a bandwidth of the channel corresponding to the second receiving bandwidth is a second multiple of the channel bandwidth of the one channel.

Exemplarily, for a zero-power device supporting an IF-based receiver, the frequency band from 920 MHz to 925 MHz contains 20 second channels, and each second channel occupies a bandwidth of 250 kHz. In this case, the second channel is the first channel, and it may also be considered that no second channel is split additionally.

Alternatively, the frequency band contains 10 second channels, and each second channel contains 2 first channels. In this case, the network device may send a DL signal in either the first or the second of the 2 first channels.

In some embodiments, the network device sends a DL signal in a third channel, where a channel bandwidth of the third channel is determined based on the maximum reception capability supported by a receiver.

Exemplarily, in a 1.8 GHz frequency band or a 2.6 GHz frequency band, the third channel is a channel with a channel bandwidth of 2 MHz. A DL signal is not limited to being sent within a range of 250 kHz, but only needs to be sent within the range of 2 MHz.

In summary, in the method provided in embodiments of the present disclosure, the receiver parameter to be used by the zero-power device is determined, where the receiver parameter includes the receiver type and/or the receiving bandwidth, such that a receiver parameter corresponding to a different scenario can be determined to meet actual requirements, thereby enhancing the flexibility of the zero-power device.

In the method provided in embodiments of the present disclosure, the zero-power device uses an RF-based receiver, thereby reducing the energy consumption of the zero-power device.

In the method provided in embodiments of the present disclosure, the zero-power device uses an IF-based receiver or a zero IF-based receiver, thereby improving the transmission efficiency of the zero-power device.

In the method provided in embodiments of the present disclosure, the zero-power device sends the first information, where the first information includes the receiver capability information of the zero-power device or the receiver parameter information of the zero-power device, such that the receiver type and/or the receiving bandwidth to be used by the zero-power device can be determined.

FIG. 11 is a flowchart of a method for information transmission provided in an exemplary embodiment of the present disclosure. The method is performed by a zero-power device, and the method includes the following.

At S1110, first information is sent.

The first information includes receiver capability information of the zero-power device or receiver parameter information of the zero-power device.

In some embodiments, the receiver capability information or the receiver parameter information includes at least one of: first capability information, and second capability information, where the first capability information indicates a receiver type, and the second capability information indicates a receiving bandwidth.

In some embodiments, the first capability information includes at least one of: RF-based receiver information, IF-based receiver information, and zero IF-based receiver information.

In some embodiments, the second capability information includes at least one of: a first bandwidth value, a second bandwidth value, a first multiple of a channel bandwidth, and a second multiple of a channel bandwidth. The first bandwidth value or the first multiple of a channel bandwidth indicates a receiving bandwidth corresponding to an RF-based receiver. The second bandwidth value or the second multiple of a channel bandwidth indicates a receiving bandwidth corresponding to an IF-based receiver or a zero IF-based receiver. The first bandwidth value is greater than the second bandwidth value. The first multiple is greater than the second multiple.

For specific implementation details, reference may be made to the first information in the embodiment as illustrated in FIG. 8, which will not be repeated herein.

In summary, in the method provided in embodiments of the present disclosure, the zero-power device sends the first information, where the first information includes the receiver capability information of the zero-power device or the receiver parameter information of the zero-power device, such that the receiver type and/or the receiving bandwidth to be used by the zero-power device can be determined.

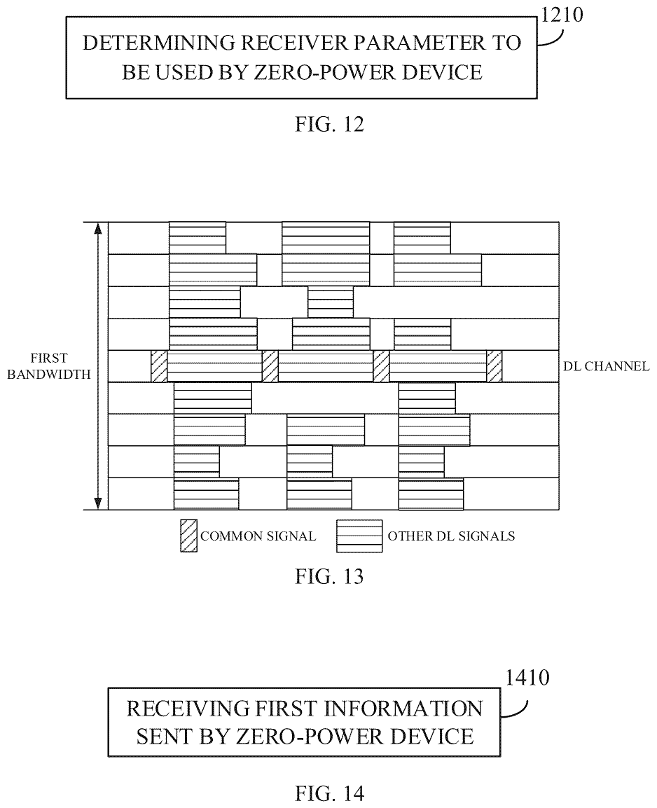

FIG. 12 is a flowchart of a method for determining a receiver parameter provided in an exemplary embodiment of the present disclosure. The method is performed by a network device, and the method includes the following.

At S1210, a receiver parameter to be used by a zero-power device is determined.

In some embodiments, the receiver parameter includes a receiver type and/or a receiving bandwidth.

In some embodiments, the zero-power device supports at least two receivers, or the zero-power device supports at least two types of receiver parameters. The network device sends a notification message to the zero-power device, where the notification message indicates the receiver parameter.

In some embodiments, the notification message is sent by the network device based on a communication scenario.

In some embodiments, the notification message is a first notification message. The first notification message is used to notify the zero-power device to use a first receiver parameter, where the first receiver parameter includes a first receiver type and/or a first receiving bandwidth.

In some embodiments, the notification message is a second notification message. The second notification message is used to notify the zero-power device to use a second receiver parameter, where the second receiver parameter includes a second receiver type and/or a second receiving bandwidth.

In some embodiments, the zero-power device supports at least two receivers, or the zero-power device supports at least two types of receiver parameters. The receiver parameter is determined based on a communication process.

In some embodiments, it is determined that the zero-power device is to use a first receiver parameter in the case where the communication process is a first communication process, where the first communication process includes a cell search process or a beacon frame signal scan process, and the first receiver parameter includes a first receiver type and/or a first receiving bandwidth.

In some embodiments, it is determined that the zero-power device is to use a second receiver parameter in the case where the communication process is a second communication process, where the second communication process includes a data communication process, and the second receiver parameter includes a second receiver type and/or a second receiving bandwidth.

In some embodiments, the first receiver type is an RF-based receiver type.

In some embodiments, the second receiver type is an IF-based receiver type or a zero IF-based receiver type.

In some embodiments, a DL signal is sent in the case where the zero-power device uses the first receiver parameter.

In some embodiments, a DL signal is sent through one channel in a channel group in the case where the zero-power device uses the first receiver parameter, where the channel group contains at least two channels. Alternatively, a DL signal is sent through a channel corresponding to the first receiving bandwidth in the case where the zero-power device uses the first receiver parameter.

In some embodiments, a bandwidth of the channel group is a first multiple of a channel bandwidth of the one channel, or a bandwidth of the channel corresponding to the first receiving bandwidth is a first multiple of the channel bandwidth of the one channel.

In some embodiments, a DL signal is sent in the case where the zero-power device uses the second receiver parameter.

In some embodiments, a DL signal is sent through one channel in a channel group in the case where the zero-power device uses the second receiver parameter, where the channel group contains at least one channel. Alternatively, a DL signal is sent through a channel corresponding to the second receiving bandwidth in the case where the zero-power device uses the second receiver parameter.

In some embodiments, a bandwidth of the channel group is a second multiple of a channel bandwidth of the one channel, or a bandwidth of the channel corresponding to the second receiving bandwidth is a second multiple of the channel bandwidth of the one channel.

In some embodiments, the channel is determined based on a communication protocol and is used for sending a DL signal, and a channel bandwidth of the channel is determined based on a communication protocol.

In some embodiments, a DL signal is not sent through another channel other than the one channel in the channel group, or an occupancy signal is sent through another channel other than the one channel in the channel group.

In some embodiments, the channel used for sending a DL signal is a most central channel in the channel group, or the channel used for sending a DL signal is one of two most central channels in the channel group.

In some embodiments, the network device receives a UL signal sent by the zero-power device.

In some embodiments, a bandwidth occupied for the UL signal is the same or different in the case where a different receiver parameter is used.

In some embodiments, the network device broadcasts a supported zero-power device type or a zero-power device type allowed to access.

In some embodiments, the supported zero-power device type or the zero-power device type allowed to access is determined by the network device based on a communication scenario.

In some embodiments, the network device broadcasts the supported zero-power device type or the zero-power device type allowed to access by sending a broadcast signal or a beacon frame signal.

For specific implementation details, reference may be made to the operations at S710 in the embodiment as illustrated in FIG. 7, which will not be repeated herein.

In some embodiments, the network device sends a common signal, where the common signal is used by the zero-power device to perform cell search or beacon frame scanning, and the common signal includes a synchronization signal, a broadcast signal, or a beacon frame signal.

To ensure that the zero-power device can use an RF-based receiver during cell search or beacon frame scan, the network device is required to consider a receiving bandwidth of the RF-based receiver when sending a synchronization signal, a broadcast signal, or a beacon frame signal. As illustrated in the foregoing embodiments, the receiving bandwidth is typically greater than the channel bandwidth, for example, may be M times the channel bandwidth, where M is a positive integer.

In some embodiments, the common signal is sent in a DL channel, and a bandwidth occupied for the DL channel is less than or equal to one channel bandwidth.

In some embodiments, the network device sends only the common signal in a first bandwidth centered on the DL channel, where the first bandwidth is greater than or equal to a receiving bandwidth of the zero-power device.

FIG. 13 is a schematic diagram illustrating a method for signal transmission provided in an exemplary embodiment of the present disclosure. When a network device sends a common signal, the common signal is sent in one DL channel (occupying a bandwidth no greater than one channel bandwidth), and in a first bandwidth centered on the common signal (where the first bandwidth is greater than or equal to the receiving bandwidth), no other DL signals can be sent by the network device except the common signal. During other times when the common signal is not sent, other DL signals can be sent in all channels.

In some embodiments, when operating in an unlicensed frequency band, the network device also needs to occupy the first bandwidth, to ensure that another device does not send any signal in the first bandwidth during transmission of the common signal. For example, before sending the common signal, the network device may send an occupancy signal (preamble) in each channel in the first bandwidth and indicate an occupation duration (which is not shorter than a duration for sending the common signal). Alternatively, when other network device(s) monitors the common signal, the other network device(s) does not send any signal in the first bandwidth corresponding to the common signal.

In some embodiments, the network device receives first information sent by the zero-power device, where the first information includes receiver capability information of the zero-power device or receiver parameter information of the zero-power device.

In some embodiments, the receiver capability information or the receiver parameter information includes at least one of: first capability information, and second capability information, where the first capability information indicates a receiver type, and the second capability information indicates a receiving bandwidth.

In some embodiments, the first capability information includes at least one of: RF-based receiver information, IF-based receiver information, and zero IF-based receiver information.

In some embodiments, the second capability information includes at least one of: a first bandwidth value, a second bandwidth value, a first multiple of a channel bandwidth, and a second multiple of a channel bandwidth. The first bandwidth value or the first multiple of a channel bandwidth indicates a receiving bandwidth corresponding to an RF-based receiver. The second bandwidth value or the second multiple of a channel bandwidth indicates a receiving bandwidth corresponding to an IF-based receiver or a zero IF-based receiver. The first bandwidth value is greater than the second bandwidth value. The first multiple is greater than the second multiple.

For the specific implementation details of the method for determining the receiver parameter, reference may be made to those in the zero-power device side, which will not be repeated herein.

In summary, in the method provided in embodiments of the present disclosure, the receiver parameter to be used by the zero-power device is determined, where the receiver parameter includes the receiver type and/or the receiving bandwidth, such that a receiver parameter corresponding to a different scenario can be determined to meet actual requirements, thereby enhancing the flexibility of the zero-power device.

In the method provided in embodiments of the present disclosure, the zero-power device is instructed to use an RF-based receiver, thereby reducing the energy consumption of the zero-power device.

In the method provided in embodiments of the present disclosure, the zero-power device is instructed to use an IF-based receiver or a zero IF-based receiver, thereby improving the transmission efficiency of the zero-power device.

In the method provided in embodiments of the present disclosure, the zero-power device sends the first information, where the first information includes the receiver capability information of the zero-power device or the receiver parameter information of the zero-power device, such that the receiver type and/or the receiving bandwidth to be used by the zero-power device can be determined.

In the method provided in embodiments of the present disclosure, the network device broadcasts the supported zero-power device type or the zero-power device type allowed to access, such that only a zero-power device corresponding to the zero-power device type can access the network device, or the zero-power device may adjust its used receiver to match the zero-power device type supported by the network device or the zero-power device type allowed to access the network device.

FIG. 14 is a flowchart of a method for information transmission provided in an exemplary embodiment of the present disclosure. The method is performed by a network device, and the method includes the following.

At S1410, first information sent by a zero-power device is received.

In some embodiments, the first information includes receiver capability information of the zero-power device or receiver parameter information of the zero-power device.

In some embodiments, the receiver capability information or the receiver parameter information includes at least one of: first capability information, and second capability information, where the first capability information indicates a receiver type, and the second capability information indicates a receiving bandwidth.

In some embodiments, the first capability information includes at least one of: RF-based receiver information, IF-based receiver information, and zero IF-based receiver information.

In some embodiments, the second capability information includes at least one of: a first bandwidth value, a second bandwidth value, a first multiple of a channel bandwidth, and a second multiple of a channel bandwidth. The first bandwidth value or the first multiple of a channel bandwidth indicates a receiving bandwidth corresponding to an RF-based receiver. The second bandwidth value or the second multiple of a channel bandwidth indicates a receiving bandwidth corresponding to an IF-based receiver or a zero IF-based receiver. The first bandwidth value is greater than the second bandwidth value. The first multiple is greater than the second multiple.

For specific implementation details of the method for information transmission, reference may be made to those in the zero-power device side, which will not be repeated herein.

In summary, in the method provided in embodiments of the present disclosure, the first information sent by the zero-power device is received, where the first information includes the receiver capability information of the zero-power device or the receiver parameter information of the zero-power device, such that the receiver type and/or the receiving bandwidth to be used by the zero-power device can be determined.

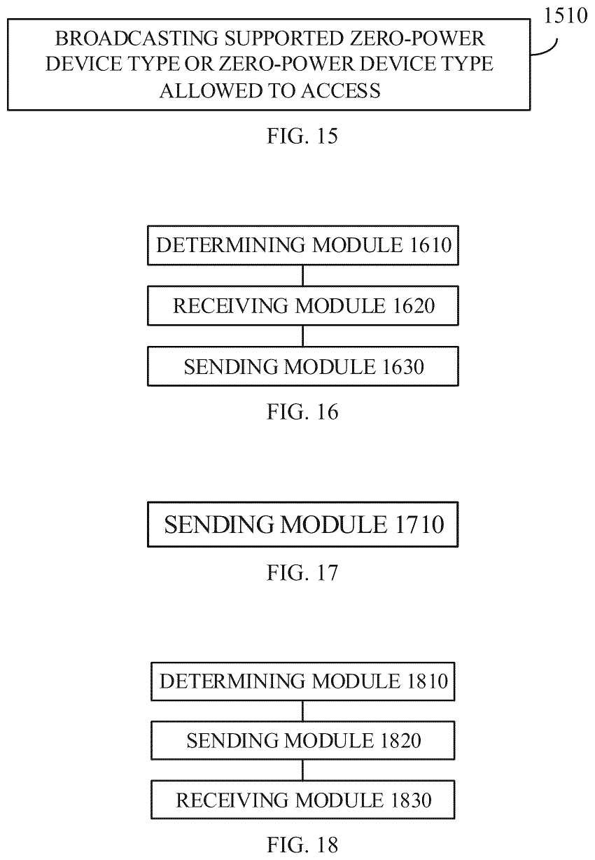

FIG. 15 is a flowchart of the method for information transmission provided in an exemplary embodiment of the present disclosure. The method is performed by a network device, and the method includes the following.

At S1510, a supported zero-power device type or a zero-power device type allowed to access is broadcast.

In some embodiments, the network device broadcasts the supported zero-power device type or the zero-power device type allowed to access.

In some embodiments, the supported zero-power device type or the zero-power device type allowed to access is determined by the network device based on a communication scenario.

In some embodiments, the network device broadcasts the supported zero-power device type or the zero-power device type allowed to access by sending a broadcast signal or a beacon frame signal.

For the specific implementation details of the method for information transmission, reference may be made to the embodiment as illustrated in FIG. 13, which will not be repeated herein.

In summary, in the method provided in embodiments of the present disclosure, the supported zero-power device type or the zero-power device type allowed to access is broadcast, such that only a zero-power device corresponding to the zero-power device type can access the network device, or the zero-power device may adjust its used receiver to match the zero-power device type supported by the network device or the zero-power device type allowed to access the network device.

In the foregoing embodiments, a step with a same sequence number may be considered as the same step. The embodiment corresponding to FIG. 7, the embodiment corresponding to FIG. 8, the embodiment corresponding to FIG. 11, the embodiment corresponding to FIG. 12, the embodiment corresponding to FIG. 14, and the embodiment corresponding to FIG. 15 may be implemented separately or in combination, which is not limited in the present disclosure.

FIG. 16 is a block diagram of a zero-power apparatus provided in an exemplary embodiment of the present disclosure. The zero-power apparatus may be implemented as a zero-power device or as a part of a zero-power device through software, hardware, or a combination thereof. The zero-power apparatus includes a determining module 1610, a receiving module 1620, and a sending module 1630. The function(s) of the determining module 1610 may be implemented by a processor of the zero-power device, the function(s) of the receiving module 1620 may be implemented by a receiver of the zero-power device, and the function(s) of the sending module 1630 may be implemented by a transmitter of the zero-power device.

The determining module 1610 is configured to determine a receiver parameter to be used by the zero-power apparatus, where the receiver parameter includes a receiver type and/or a receiving bandwidth.

In a possible design of this embodiment, the receiver type indicates a receiver architecture type to be used by the zero-power apparatus, such as an RF-based receiver and an IF (zero IF)-based receiver. The receiving bandwidth indicates a bandwidth for signal reception.

In a possible design of this embodiment, the zero-power apparatus supports at least two receivers, or the zero-power apparatus supports at least two types of receiver parameters. The receiver parameter is determined based on a notification message sent by a network-side apparatus.

In a possible design of this embodiment, the notification message is sent by the network-side apparatus based on a communication scenario.

Exemplarily, the network-side apparatus sends a first notification message in communication scenarios with a relatively low demand for the number of zero-power apparatus, such as a smart home scenario, and sends a second notification message in communication scenarios with a relatively high demand for the number of zero-power apparatus, such as an industrial intelligence scenario.

In a possible design of this embodiment, the notification message is a first notification message. The first notification message is used to notify the zero-power apparatus to use a first receiver parameter, where the first receiver parameter includes a first receiver type and/or a first receiving bandwidth.

In a possible design of this embodiment, the first receiver type is an RF-based receiver type.

The first notification message is sent by the network-side apparatus in a communication scenario where the required number of zero-power apparatus is less than a first threshold, where the first threshold is determined or predefined based on a communication protocol. For example, in the smart home scenario, the first notification message is sent to notify the zero-power apparatus to use an RF-based receiver, with the first receiving bandwidth of four channel bandwidths.

In a possible design of this embodiment, the notification message is a second notification message. The second notification message is used to notify the zero-power apparatus to use a second receiver parameter, where the second receiver parameter includes a second receiver type and/or a second receiving bandwidth.

In a possible design of this embodiment, the second receiver type is an IF-based receiver type or a zero IF-based receiver type.

The second notification message is sent by the network-side apparatus in a communication scenario where the required number of zero-power apparatus exceeds a second threshold, where the second threshold is determined or predefined based on a communication protocol. For example, in the industrial intelligent scenario, the second notification message is sent to notify zero-power apparatus to use an IF (zero IF)-based receiver, with the second receiving bandwidth of two channel bandwidths.

In a possible design of this embodiment, the receiving module 1620 is configured to receive a DL signal sent by the network-side apparatus in the case where the zero-power apparatus uses the first receiver parameter.

A zero-power apparatus using a different receiver type has a different requirement for the network, such as a different receiving bandwidth. When an RF-based receiver is used, the receiving bandwidth is relatively wide, for example, the receiving bandwidth is M channel bandwidths. When the channel bandwidth is 250 kHz and M=8, the receiving bandwidth is 2 MHz. As a result, when the network-side apparatus sends a DL signal (e.g., the DL signal is sent within one channel, occupying a bandwidth of no more than 250 kHz), there can be no signal sent to another zero-power apparatus within the 2 MHz receiving bandwidth of the zero-power apparatus. In other words, within the 2 MHz receiving bandwidth, even though the DL signal sent by the network-side apparatus occupies the bandwidth of no more than 250 kHz, the remaining bandwidth shall not be used to send a DL signal to another zero-power apparatus or another device.

As illustrated in FIG. 9, the receiving bandwidth spans eight channel bandwidths, occupying Channel 7 to Channel 14. Channel 11 is an available channel for sending a DL signal, and the remaining seven channels serve as guard bands within which no other signal is sent. This is because a zero-power apparatus typically employs relatively simple DL signal waveforms, and if another signal is sent within the bandwidth, the DL signal of the zero-power apparatus may be interfered with and cannot be demodulated. However, an IF-based receiver or a zero IF-based receiver only requires a relatively narrow receiving bandwidth, such as a bandwidth of one channel or a bandwidth of N channels, where N=1, 2, or 3, and N<M.

In a possible design of this embodiment, when the zero-power apparatus supporting at least two receivers communicates with the network-side apparatus, the method includes at least one of the following.

(1) The zero-power apparatus sends receiver type information and/or receiving bandwidth information (e.g., a value of the receiving bandwidth, where the receiving bandwidth is a multiple of a channel bandwidth) to the network-side apparatus.

In a possible design of this embodiment, the sending module 1630 is configured to send first information, where the first information includes receiver capability information of the zero-power apparatus or receiver parameter information of the zero-power apparatus.

In a possible design of this embodiment, the receiver capability information or the receiver parameter information includes at least one of: first capability information, and second capability information, where the first capability information indicates a receiver type, and the second capability information indicates a receiving bandwidth.

In a possible design of this embodiment, the first capability information indicates a receiver type supported by the zero-power apparatus, and the second capability information indicates a bandwidth for signal reception.

In a possible design of this embodiment, the first capability information includes at least one of: RF-based receiver information, IF-based receiver information, and zero IF-based receiver information.

In a possible design of this embodiment, the zero-power apparatus supports any one of the above receivers, or supports both an RF-based receiver and an IF-based receiver, or supports both an RF-based receiver and a zero IF-based receiver, or supports all three types of receivers, or supports other types of receivers, which is not limited in embodiments of the present disclosure.

In a possible design of this embodiment, the second capability information includes at least one of: a first bandwidth value, a second bandwidth value, a first multiple of a channel bandwidth, and a second multiple of a channel bandwidth. The first bandwidth value or the first multiple of a channel bandwidth indicates a receiving bandwidth corresponding to an RF-based receiver. The second bandwidth value or the second multiple of a channel bandwidth indicates a receiving bandwidth corresponding to an IF-based receiver or a zero IF-based receiver. The first bandwidth value is greater than the second bandwidth value. The first multiple is greater than the second multiple, and the first multiple and the second multiple each are a positive integer.

In a possible design of this embodiment, a channel is determined based on a communication protocol and is used for sending a DL signal, and a channel bandwidth of the channel is determined based on a communication protocol. For example, one channel bandwidth is 250 kHz. Exemplarily, a receiving bandwidth of the RF-based receiver is 1000 kHz or four channel bandwidths, and a receiving bandwidth of the IF (zero IF)-based receiver is 250 kHz or one channel bandwidth.

(2) Based on different communication scenarios, the network-side apparatus only supports a zero-power apparatus of a specified receiver type, and within the coverage of the network-side apparatus, only the zero-power apparatus of the specified receiver type is used.

In a possible design of this embodiment, the network-side apparatus broadcasts a supported zero-power apparatus type or a zero-power apparatus type allowed to access by sending a broadcast signal or a beacon frame signal.

Based on the supported zero-power apparatus type or the zero-power apparatus type allowed to access that is broadcast by the network-side apparatus, only a zero-power apparatus corresponding to the zero-power apparatus type can access the network-side apparatus, or the zero-power apparatus may adjust its used receiver to match the zero-power apparatus type supported by the network-side apparatus or the zero-power apparatus type allowed to access the network-side apparatus.

In a possible design of this embodiment, the sending module 1630 is configured to send a UL signal to the network-side apparatus in response to receiving the DL signal.

In a possible design of this embodiment, a bandwidth occupied for the UL signal is the same or different in the case where a different receiver parameter is used.

Exemplarily, for a zero-power apparatus supporting an RF-based receiver, its receiving bandwidth is eight times the channel bandwidth, and the bandwidth occupied for the UL signal is one times the channel bandwidth. For a zero-power apparatus supporting an IF-based receiver, its receiving bandwidth is one times the channel bandwidth, and the bandwidth occupied for the UL signal is also one times the channel bandwidth. That is, in the case where two receiver parameters are used, the bandwidth occupied for the UL signal is the same.

In a possible design of this embodiment, the zero-power apparatus supports at least two receivers, or the zero-power apparatus supports at least two types of receiver parameters. The receiver parameter is determined based on a communication process.

The communication process includes processes such as cell search, beacon frame signal scan, data communication, etc.

In a possible design of this embodiment, the determining module 1610 is configured to determine that the zero-power apparatus is to use a first receiver parameter in the case where the communication process is a first communication process, where the first communication process includes a cell search process or a beacon frame signal scan process, and the first receiver parameter includes a first receiver type and/or a first receiving bandwidth.

Exemplarily, in the case where the communication process is cell search, it is determined that the zero-power apparatus is to use an RF-based receiver, and the first receiving bandwidth is four channel bandwidths. Since cell search typically lasts for a period of time, using an RF-based receiver is conducive to saving power.

In a possible design of this embodiment, the determining module 1610 is configured to determine that the zero-power apparatus is to use a second receiver parameter in the case where the communication process is a second communication process, where the second communication process includes a data communication process, and the second receiver parameter includes a second receiver type and/or a second receiving bandwidth.

Exemplarily, in the case where the communication process is data communication, it is determined that the zero-power apparatus is to use an IF (zero IF)-based receiver, and the second receiving bandwidth is two channel bandwidths. During data communication, using an IF (zero-IF)-based receiver can enhance transmission efficiency.

As illustrated in FIG. 10, based on a communication protocol of a related region, a frequency band from 920 MHz to 925 MHz is split into 20 channels, and each channel occupies a bandwidth of 250 kHz. When a zero-power apparatus is deployed within the frequency band, a transmission by both a network-side apparatus and the zero-power apparatus shall adhere to the method for channel splitting. To support a different receiver, a new method for splitting may be established based on this.

In a possible design of this embodiment, the receiving module 1620 is configured to receive a DL signal sent by the network-side apparatus through one channel in a channel group in the case where the zero-power apparatus uses the first receiver parameter, where the channel group contains at least two channels. Alternatively, the receiving module 1620 is configured to receive a DL signal through a channel corresponding to the first receiving bandwidth in the case where the zero-power apparatus uses the first receiver parameter.

In a possible design of this embodiment, a bandwidth of the channel group is a first multiple of a channel bandwidth of the one channel, or a bandwidth of the channel corresponding to the first receiving bandwidth is a first multiple of the channel bandwidth of the one channel.

In a possible design of this embodiment, the channel is determined based on a communication protocol and is used for sending a DL signal, and a channel bandwidth of the channel is determined based on a communication protocol.

Exemplarily, in a new method for splitting, a frequency band contains X channel groups, and each channel group contains M first channels, where the first channel is determined based on a communication protocol and is used for sending a DL signal, for example, X=4, M=5, and X may be either an odd or an even. In this case, a DL signal is sent according to a bandwidth of the channel group, where the bandwidth of the channel group is a first multiple of a channel bandwidth of the first channel.

Alternatively, the frequency band contains X second channels, where a channel bandwidth of the second channel is M times the channel bandwidth of the first channel, for example, X=4, M=5, and X may be either an odd or an even. In this case, a DL signal is sent according to the channel bandwidth of the second channel, where the channel bandwidth of the second channel is the first multiple of the channel bandwidth of the first channel.

In a possible design of this embodiment, a DL signal is not sent through another channel other than the one channel in the channel group, or an occupancy signal is sent through another channel other than the one channel in the channel group.

When the network-side apparatus sends a DL signal to the zero-power apparatus, the DL signal is sent only through the first channel, and the DL signal is not sent or an occupancy signal is sent through another channel other than the first channel.

In a possible design of this embodiment, the channel used for sending a DL signal is a most central channel in the channel group, or the channel used for sending a DL signal is one of two most central channels in the channel group.

In the case where the channel group contains an odd number of channels, the channel used for sending a DL signal is the most central channel in the channel group. In the case where the channel group contains an even number of channels, the channel used for sending a DL signal is one of the two most central channels in the channel group.

Exemplarily, the second channel contains five channels, and the first channel (used for sending a DL signal) is the most central channel (the third of the five channels). Alternatively, the second channel contains four channels, and the first channel is one of the two most central channels (the second or the third of the four channels).

When X=2, each second channel occupies a bandwidth of 2.5 MHz, each second channel contains M=10 first channels, and the network-side apparatus may send a DL signal in the fifth channel or the sixth channel. Similarly, when X=1, M=20; and when X=5, M=4.

In a possible design of this embodiment, the receiving module 1620 is configured to receive a DL signal sent by the network-side apparatus in the case where the zero-power apparatus uses the second receiver parameter.

In a possible design of this embodiment, the receiving module 1620 is configured to receive a DL signal sent by the network-side apparatus through one channel in a channel group in the case where the zero-power apparatus uses the second receiver parameter, where the channel group contains at least one channel. Alternatively, the receiving module 1620 is configured to receive a DL signal through a channel corresponding to the second receiving bandwidth in the case where the zero-power apparatus uses the second receiver parameter.

In a possible design of this embodiment, a bandwidth of the channel group is a second multiple of a channel bandwidth of the one channel, or a bandwidth of the channel corresponding to the second receiving bandwidth is a second multiple of the channel bandwidth of the one channel.

Exemplarily, for a zero-power apparatus supporting an IF-based receiver, the frequency band from 920 MHz to 925 MHz contains 20 second channels (channel group), and each second channel occupies a bandwidth of 250 kHz. In this case, the second channel is the first channel, and it may also be considered that no second channel is split additionally.

Alternatively, the frequency band contains 10 second channels, and each second channel contains 2 first channels. In this case, the network-side apparatus may send a DL signal in either the first or the second of the 2 first channels.

In some embodiments, the network-side apparatus sends a DL signal in a third channel, where a channel bandwidth of the third channel is determined based on the maximum reception capability supported by a receiver.

Exemplarily, in a 1.8 GHz frequency band or a 2.6 GHz frequency band, the third channel is a channel with a channel bandwidth of 2 MHz. A DL signal is not limited to being sent within a range of 250 kHz, but only needs to be sent within the range of 2 MHz.

In this embodiment, the determining module 1610 may be divided into multiple determining modules, such as a first determining module and a second determining module. The first determining module may be configured to determine that the zero-power apparatus is to use a first receiver parameter, and the second determining module may be configured to determine that the zero-power apparatus is to use a second receiver parameter. Alternatively, the first determining module may be configured to determine that the zero-power apparatus is to use a second receiver parameter, and the second determining module may be configured to determine that the zero-power apparatus is to use a first receiver parameter. The function(s) of a different determining module is not limited in embodiments of the present disclosure.

In this embodiment, the receiving module 1620 may be divided into multiple receiving modules, such as a first receiving module and a second receiving module. The first receiving module may be configured to receive a DL signal through a channel corresponding to the first receiving bandwidth, and the second receiving module may be configured to receive a DL signal through a channel corresponding to the second receiving bandwidth. Alternatively, the first receiving module may be configured to receive a DL signal through the channel corresponding to the second receiving bandwidth, and the second receiving module may be configured to receive a DL signal through the channel corresponding to the first receiving bandwidth. The function(s) of a different receiving module is not limited in embodiments of the present disclosure.

In this embodiment, the sending module 1630 may be divided into multiple sending modules, such as a first sending module and a second sending module. The first sending module may be configured to send a UL signal to the network-side apparatus in response to receiving a DL signal, and the second sending module may be configured to send first information. Alternatively, the first sending module may be configured to send first information, and the second sending module may be configured to send a UL signal to the network-side apparatus in response to receiving a DL signal. The function(s) of a different sending module is not limited in embodiments of the present disclosure.

In embodiments of the present disclosure, one determining module 1610 is illustrated as an example, and the number of determining modules 1610 is not limited.

In embodiments of the present disclosure, one receiving module 1620 is illustrated as an example, and the number of receiving modules 1620 is not limited.

In embodiments of the present disclosure, one sending module 1630 is illustrated as an example, and the number of sending modules 1630 is not limited.

For the illustration of the function(s) of the determining module 1610, reference may be made to the operations at S750 in the embodiment as illustrated in FIG. 7 and the operations at S810 in the embodiment as illustrated in FIG. 8.

For the illustration of the function(s) of the receiving module 1620, reference may be made to the operations at S740 in the embodiment as illustrated in FIG. 7 and the operations at S810 in the embodiment as illustrated in FIG. 8.

For the illustration of the function(s) of the sending module 1630, reference may be made to the operations at S720 in the embodiment as illustrated in FIG. 7, the operations at S810 in the embodiment as illustrated in FIG. 8, and the operations at S1110 in the embodiment as illustrated in FIG. 11.

FIG. 17 is a block diagram of a zero-power apparatus provided in an exemplary embodiment of the present disclosure. The zero-power apparatus may be implemented as a zero-power device or as a part of a zero-power device through software, hardware, or a combination thereof. The zero-power apparatus includes a sending module 1710, where the function(s) of the sending module 1710 is implemented by a transmitter of the zero-power device.

The sending module 1710 is configured to send first information, where the first information includes receiver capability information of the zero-power apparatus or receiver parameter information of the zero-power apparatus.

In a possible design of this embodiment, the receiver capability information or the receiver parameter information includes at least one of: first capability information, and second capability information, where the first capability information indicates a receiver type, and the second capability information indicates a receiving bandwidth.

In a possible design of this embodiment, the first capability information indicates a receiver type supported by the zero-power apparatus, and the second capability information indicates a bandwidth for signal reception.

In a possible design of this embodiment, the first capability information includes at least one of: RF-based receiver information, IF-based receiver information, and zero IF-based receiver information.

In a possible design of this embodiment, the zero-power apparatus supports any one of the above receivers, or supports both an RF-based receiver and an IF-based receiver, or supports both an RF-based receiver and a zero IF-based receiver, or supports all three types of receivers, or supports other types of receivers, which is not limited in embodiments of the present disclosure.

In a possible design of this embodiment, the second capability information includes at least one of: a first bandwidth value, a second bandwidth value, a first multiple of a channel bandwidth, and a second multiple of a channel bandwidth. The first bandwidth value or the first multiple of a channel bandwidth indicates a receiving bandwidth corresponding to an RF-based receiver. The second bandwidth value or the second multiple of a channel bandwidth indicates a receiving bandwidth corresponding to an IF-based receiver or a zero IF-based receiver. The first bandwidth value is greater than the second bandwidth value. The first multiple is greater than the second multiple, and the first multiple and the second multiple each are a positive integer.

In a possible design of this embodiment, a channel is determined based on a communication protocol and is used for sending a DL signal, and a channel bandwidth of the channel is determined based on a communication protocol. For example, one channel bandwidth is 250 kHz. Exemplarily, a receiving bandwidth of the RF-based receiver is 1000 kHz or four channel bandwidths, and a receiving bandwidth of the IF (zero IF)-based receiver is 250 kHz or one channel bandwidth.

In embodiments of the present disclosure, one sending module 1710 is illustrated as an example, and the number of sending modules 1710 is not limited.

For the illustration of the function(s) of the sending module 1710, reference may be made to the operations at S720 in the embodiment as illustrated in FIG. 7, the operations at S810 in the embodiment as illustrated in FIG. 8, and the operations at S1110 in the embodiment as illustrated in FIG. 11.

FIG. 18 is a block diagram of a network-side apparatus provided in an exemplary embodiment of the present disclosure. The network-side apparatus may be implemented as a network device or a part of a network device through software, hardware, or a combination thereof. The network-side apparatus includes a determining module 1810, a sending module 1820, and a receiving module 1830. The function(s) of the determining module 1810 is implemented by a processor of the network device. The function(s) of the sending module 1820 is implemented by a transmitter of the network device. The function(s) of the receiving module 1830 is implemented by a receiver of the network device.

The determining module 1810 is configured to determine a receiver parameter to be used by a zero-power apparatus, where the receiver parameter includes a receiver type and/or a receiving bandwidth.

In a possible design of this embodiment, the receiver type indicates a receiver architecture type to be used by the zero-power apparatus, such as an RF-based receiver and an IF (zero IF)-based receiver. The receiving bandwidth indicates a bandwidth for signal reception.

In a possible design of this embodiment, the zero-power apparatus supports at least two receivers, or the zero-power apparatus supports at least two types of receiver parameters.

The sending module 1820 is configured to send a notification message to the zero-power apparatus, where the notification message indicates the receiver parameter.

In a possible design of this embodiment, the notification message is sent by the network-side apparatus based on a communication scenario.

Exemplarily, the network-side apparatus sends a first notification message in communication scenarios with a relatively low demand for the number of zero-power apparatus, such as a smart home scenario, and sends a second notification message in communication scenarios with a relatively high demand for the number of zero-power apparatus, such as an industrial intelligence scenario.

In a possible design of this embodiment, the notification message is a first notification message. The first notification message is used to notify the zero-power apparatus to use a first receiver parameter, where the first receiver parameter includes a first receiver type and/or a first receiving bandwidth.

In a possible design of this embodiment, the first receiver type is an RF-based receiver type.

The first notification message is sent by the network-side apparatus in a communication scenario where the required number of zero-power apparatus is less than a first threshold, where the first threshold is determined or predefined based on a communication protocol. For example, in the smart home scenario, the first notification message is sent to notify the zero-power apparatus to use an RF-based receiver, with the first receiving bandwidth of four channel bandwidths.

In a possible design of this embodiment, the notification message is a second notification message. The second notification message is used to notify the zero-power apparatus to use a second receiver parameter, where the second receiver parameter includes a second receiver type and/or a second receiving bandwidth.

In a possible design of this embodiment, the second receiver type is an IF-based receiver type or a zero IF-based receiver type.

The second notification message is sent by the network-side apparatus in a communication scenario where the required number of zero-power apparatus exceeds a second threshold, where the second threshold is determined or predefined based on a communication protocol. For example, in the industrial intelligent scenario, the second notification message is sent to notify zero-power apparatus to use an IF (zero IF)-based receiver, with the second receiving bandwidth of two channel bandwidths.

In a possible design of this embodiment, the zero-power apparatus supports at least two receivers, or the zero-power apparatus supports at least two types of receiver parameters. The receiver parameter is determined based on a communication process.

The communication process includes processes such as cell search, beacon frame signal scan, data communication, etc.

In a possible design of this embodiment, the determining module 1810 is configured to determine that the zero-power apparatus is to use a first receiver parameter in the case where the communication process is a first communication process, where the first communication process includes a cell search process or a beacon frame signal scan process, and the first receiver parameter includes a first receiver type and/or a first receiving bandwidth.

Exemplarily, in the case where the communication process is cell search, it is determined that the zero-power apparatus is to use an RF-based receiver, and the first receiving bandwidth is four channel bandwidths. Since cell search typically lasts for a period of time, using an RF-based receiver is conducive to saving power.

In a possible design of this embodiment, the determining module 1810 is configured to determine that the zero-power apparatus is to use a second receiver parameter in the case where the communication process is a second communication process, where the second communication process includes a data communication process, and the second receiver parameter includes a second receiver type and/or a second receiving bandwidth.

Exemplarily, in the case where the communication process is data communication, it is determined that the zero-power apparatus is to use an IF (zero IF)-based receiver, and the second receiving bandwidth is two channel bandwidths. During data communication, using an IF (zero-IF)-based receiver can enhance transmission efficiency.

In a possible design of this embodiment, the sending module 1820 is configured to send a DL signal in the case where the zero-power apparatus uses the first receiver parameter.

As illustrated in FIG. 10, based on a communication protocol of a related region, a frequency band from 920 MHz to 925 MHz is split into 20 channels, and each channel occupies a bandwidth of 250 kHz. When a zero-power apparatus is deployed within the frequency band, a transmission by both a network-side apparatus and the zero-power apparatus shall adhere to the method for channel splitting. To support a different receiver, a new method for splitting may be established based on this.

In a possible design of this embodiment, the sending module 1820 is configured to send a DL signal through one channel in a channel group in the case where the zero-power apparatus uses the first receiver parameter, where the channel group contains at least two channels. Alternatively, the sending module 1820 is configured to send a DL signal through a channel corresponding to the first receiving bandwidth in the case where the zero-power apparatus uses the first receiver parameter.

In a possible design of this embodiment, a bandwidth of the channel group is a first multiple of a channel bandwidth of the one channel, or a bandwidth of the channel corresponding to the first receiving bandwidth is a first multiple of the channel bandwidth of the one channel.

In a possible design of this embodiment, the sending module 1820 is configured to send a DL signal in the case where the zero-power apparatus uses the second receiver parameter.

A zero-power apparatus using a different receiver type has a different requirement for the network, such as a different receiving bandwidth. When an RF-based receiver is used, the receiving bandwidth is relatively wide, for example, the receiving bandwidth is M channel bandwidths. When the channel bandwidth is 250 kHz and M=8, the receiving bandwidth is 2 MHz. As a result, when the network-side apparatus sends a DL signal (e.g., the DL signal is sent within one channel, occupying a bandwidth of no more than 250 kHz), there can be no signal sent to another zero-power apparatus within the 2 MHz receiving bandwidth of the zero-power apparatus. In other words, within the 2 MHz receiving bandwidth, even though the DL signal sent by the network-side apparatus occupies the bandwidth of no more than 250 kHz, the remaining bandwidth shall not be used to send a DL signal to another zero-power apparatus or another device.

As illustrated in FIG. 9, the receiving bandwidth spans eight channel bandwidths, occupying Channel 7 to Channel 14. Channel 11 is an available channel for sending a DL signal, and the remaining seven channels serve as guard bands within which no other signal is sent. This is because a zero-power apparatus typically employs relatively simple DL signal waveforms, and if another signal is sent within the bandwidth, the DL signal of the zero-power apparatus may be interfered with and cannot be demodulated. However, an IF-based receiver or a zero IF-based receiver only requires a relatively narrow receiving bandwidth, such as a bandwidth of one channel or a bandwidth of N channels, where N=1, 2, or 3, and N<M.

In a possible design of this embodiment, when the zero-power apparatus supporting at least two receivers communicates with the network-side apparatus, the method includes at least one of the following.

(1) The zero-power apparatus sends receiver type information and/or receiving bandwidth information (e.g., a value of the receiving bandwidth, where the receiving bandwidth is a multiple of a channel bandwidth) to the network-side apparatus.

In a possible design of this embodiment, the receiving module 1830 is configured to receive first information sent by the zero-power apparatus, where the first information includes receiver capability information of the zero-power apparatus or receiver parameter information of the zero-power apparatus.

In a possible design of this embodiment, the receiver capability information or the receiver parameter information includes at least one of: first capability information, and second capability information, where the first capability information indicates a receiver type, and the second capability information indicates a receiving bandwidth.

In a possible design of this embodiment, the first capability information indicates a receiver type supported by the zero-power apparatus, and the second capability information indicates a bandwidth for signal reception.

In a possible design of this embodiment, the first capability information includes at least one of: RF-based receiver information, IF-based receiver information, and zero IF-based receiver information.

In a possible design of this embodiment, the zero-power apparatus supports any one of the above receivers, or supports both an RF-based receiver and an IF-based receiver, or supports both an RF-based receiver and a zero IF-based receiver, or supports all three types of receivers, or supports other types of receivers, which is not limited in embodiments of the present disclosure.

In a possible design of this embodiment, the second capability information includes at least one of: a first bandwidth value, a second bandwidth value, a first multiple of a channel bandwidth, and a second multiple of a channel bandwidth. The first bandwidth value or the first multiple of a channel bandwidth indicates a receiving bandwidth corresponding to an RF-based receiver. The second bandwidth value or the second multiple of a channel bandwidth indicates a receiving bandwidth corresponding to an IF-based receiver or a zero IF-based receiver. The first bandwidth value is greater than the second bandwidth value. The first multiple is greater than the second multiple, and the first multiple and the second multiple each are a positive integer.

In a possible design of this embodiment, a channel is determined based on a communication protocol and is used for sending a DL signal, and a channel bandwidth of the channel is determined based on a communication protocol. For example, one channel bandwidth is 250 kHz. Exemplarily, a receiving bandwidth of the RF-based receiver is 1000 kHz or four channel bandwidths, and a receiving bandwidth of the IF (zero IF)-based receiver is 250 kHz or one channel bandwidth.

(2) Based on different communication scenarios, the network-side apparatus only supports a zero-power apparatus of a specified receiver type, and within the coverage of the network-side apparatus, only the zero-power apparatus of the specified receiver type is used.

In a possible design of this embodiment, the sending module 1820 is configured to broadcast a supported zero-power apparatus type or a zero-power apparatus type allowed to access.

In a possible design of this embodiment, the supported zero-power apparatus type or the zero-power apparatus type allowed to access is determined by the network-side apparatus based on a communication scenario.

In a possible design of this embodiment, the sending module 1820 is configured to broadcast the supported zero-power apparatus type or the zero-power apparatus type allowed to access by sending a broadcast signal or a beacon frame signal.

In a possible design of this embodiment, the supported zero-power apparatus type or the zero-power apparatus type allowed to access is determined by the network-side apparatus based on a communication scenario (referred to as “scenario” for short).

Based on factors such as communication scenarios, performance requirements, and signal coverage, the network-side apparatus determines the supported zero-power apparatus type or the zero-power apparatus type allowed to access.

Scenario 1: in scenarios such as smart homes and wearable devices, the demand for the number of zero-power apparatus is relatively low, and users focus more on the user experience. For example, the zero-power apparatus can be powered in a short time, such that the zero-power apparatus can perform functions such as communication or positioning. When a supported receiver is an RF-based receiver, due to its lower power consumption, power supply can be achieved in a shorter time. For example, when a mobile phone is used to wirelessly power the zero-power apparatus, an application generally needs to be started to trigger the mobile phone to wirelessly power the zero-power apparatus during communication with the zero-power apparatus. If the zero-power apparatus consumes less power during operation, the time of power supply by the mobile phone can be reduced, thereby reducing the energy consumption of the mobile phone.

On the other hand, although the RF-based receiver has low sensitivity and low transmission efficiency, a sensitivity range of −20 dB to −35 dB is already a current implementation limit for wireless power supply, and the RF-based receiver can achieve a sensitivity range of −35 dB to −50 dB. Additionally, in scenarios such as smart homes where the demand for the number of zero-power apparatus is relatively low, the relatively low transmission efficiency does not affect the user experience.

Scenario 2: in scenarios such as industrial intelligence or smart control, a large number of zero-power apparatus are required for environmental monitoring, production line monitoring, and asset inventory. Given the large number of zero-power apparatus in such scenarios, it is essential to provide a relatively high throughput to facilitate communication with the zero-power apparatus. For these scenarios, the zero-power apparatus supports an IF-based receiver or a zero IF-based receiver. These two types of receivers have high sensitivity and can receive signals by using relatively narrow receiving bandwidths. As a result, more zero-power apparatus can be supported to perform communication within the same frequency band, thus achieving relatively high transmission efficiency.

Scenario 3: in some scenarios, the required number of zero-power apparatus varies. For example, in a warehouse scenario, a large number of zero-power apparatus are required, but when items are delivered from a warehouse to a supermarket, fewer zero-power apparatus are required. Therefore, for such scenarios, the zero-power apparatus supports two types of receivers: an RF-based receiver and an IF (zero IF)-based receiver. The network-side apparatus can notify the zero-power apparatus to use the appropriate receiver based on the specific scenario.

In a possible design of this embodiment, the sending module 1820 is configured to broadcast the supported zero-power apparatus type or the zero-power apparatus type allowed to access is broadcast by sending a broadcast signal or a beacon frame signal.

Based on the supported zero-power apparatus type or the zero-power apparatus type allowed to access that is broadcast by the network-side apparatus, only a zero-power apparatus corresponding to the zero-power apparatus type can access the network-side apparatus, or the zero-power apparatus may adjust its used receiver to match the zero-power apparatus type supported by the network-side apparatus or the zero-power apparatus type allowed to access the network-side apparatus.

In a possible design of this embodiment, the sending module 1820 is configured to send a DL signal through one channel in a channel group in the case where the zero-power apparatus uses the second receiver parameter, where the channel group contains at least one channel. Alternatively, the sending module 1820 is configured to send a DL signal through a channel corresponding to the second receiving bandwidth in the case where the zero-power apparatus uses the second receiver parameter.

In a possible design of this embodiment, a bandwidth of the channel group is a second multiple of a channel bandwidth of the one channel, or a bandwidth of the channel corresponding to the second receiving bandwidth is a second multiple of the channel bandwidth of the one channel.

In a possible design of this embodiment, the channel is determined based on a communication protocol and is used for sending a DL signal, and a channel bandwidth of the channel is determined based on a communication protocol.

Exemplarily, in a new method for splitting, a frequency band contains X channel groups, and each channel group contains M first channels, where the first channel is determined based on a communication protocol and is used for sending a DL signal, for example, X=4, M=5, and X may be either an odd or an even. In this case, a DL signal is sent according to a bandwidth of the channel group, where the bandwidth of the channel group is a first multiple of a channel bandwidth of the first channel.

Alternatively, the frequency band contains X second channels, where a channel bandwidth of the second channel is M times the channel bandwidth of the first channel, for example, X=4, M=5, and X may be either an odd or an even. In this case, a DL signal is sent according to the channel bandwidth of the second channel, where the channel bandwidth of the second channel is the first multiple of the channel bandwidth of the first channel.

In a possible design of this embodiment, a DL signal is not sent through another channel other than the one channel in the channel group, or an occupancy signal is sent through another channel other than the one channel in the channel group.

When the network-side apparatus sends a DL signal to the zero-power apparatus, the DL signal is sent only through the first channel, and the DL signal is not sent or an occupancy signal is sent through another channel other than the first channel.

In a possible design of this embodiment, the channel used for sending a DL signal is a most central channel in the channel group, or the channel used for sending a DL signal is one of two most central channels in the channel group.

In the case where the channel group contains an odd number of channels, the channel used for sending a DL signal is the most central channel in the channel group. In the case where the channel group contains an even number of channels, the channel used for sending a DL signal is one of the two most central channels in the channel group.

Exemplarily, the second channel contains five channels, and the first channel (used for sending a DL signal) is the most central channel (the third of the five channels). Alternatively, the second channel contains four channels, and the first channel is one of the two most central channels (the second or the third of the four channels).

When X=2, each second channel occupies a bandwidth of 2.5 MHz, each second channel contains M=10 first channels, and the network-side apparatus may send a DL signal in the fifth channel or the sixth channel. Similarly, when X=1, M=20; and when X=5, M=4.

In a possible design of this embodiment, the receiving module 1830 is configured to receive a UL signal sent by the zero-power apparatus.

In a possible design of this embodiment, a bandwidth occupied for the UL signal is the same or different in the case where a different receiver parameter is used.

Exemplarily, for a zero-power apparatus supporting an RF-based receiver, its receiving bandwidth is eight times the channel bandwidth, and the bandwidth occupied for the UL signal is one times the channel bandwidth. For a zero-power apparatus supporting an IF-based receiver, its receiving bandwidth is one times the channel bandwidth, and the bandwidth occupied for the UL signal is also one times the channel bandwidth. That is, in the case where two receiver parameters are used, the bandwidth occupied for the UL signal is the same.

In a possible design of this embodiment, the sending module 1820 is configured to send a common signal, where the common signal is used by the zero-power apparatus to perform cell search or beacon frame scanning, and the common signal includes a synchronization signal, a broadcast signal, or a beacon frame signal.

To ensure that the zero-power apparatus can use an RF-based receiver during cell search or beacon frame scan, the network-side apparatus is required to consider a receiving bandwidth of the RF-based receiver when sending a synchronization signal, a broadcast signal, or a beacon frame signal. As illustrated in the foregoing embodiments, the receiving bandwidth is typically greater than the channel bandwidth, for example, may be M times the channel bandwidth, where M is a positive integer.

In a possible design of this embodiment, the common signal is sent in a DL channel, and a bandwidth occupied for the DL channel is less than or equal to one channel bandwidth.

In a possible design of this embodiment, the sending module 1820 is configured to send only the common signal in a first bandwidth centered on the DL channel, where the first bandwidth is greater than or equal to a receiving bandwidth of the zero-power apparatus.

As illustrated in FIG. 13, when a network-side apparatus sends a common signal, the common signal is sent in one DL channel (occupying a bandwidth no greater than one channel bandwidth), and in a first bandwidth centered on the common signal (where the first bandwidth is greater than or equal to the receiving bandwidth), no other DL signals can be sent by the network-side apparatus except the common signal. During other times when the common signal is not sent, other DL signals can be sent in all channels.

In a possible design of this embodiment, when operating in an unlicensed frequency band, the network-side apparatus also needs to occupy the first bandwidth, to ensure that another device does not send any signal in the first bandwidth during transmission of the common signal. For example, before sending the common signal, the network-side apparatus may send an occupancy signal (preamble) in each channel in the first bandwidth and indicate an occupation duration (which is not shorter than a duration for sending the common signal). Alternatively, when other network-side apparatus monitors the common signal, the other network-side apparatus does not send any signal in the first bandwidth corresponding to the common signal.

In some embodiments, the network-side apparatus sends a DL signal in a third channel, where a channel bandwidth of the third channel is determined based on the maximum reception capability supported by a receiver.

Exemplarily, in a 1.8 GHz frequency band or a 2.6 GHz frequency band, the third channel is a channel with a channel bandwidth of 2 MHz. A DL signal is not limited to being sent within a range of 250 kHz, but only needs to be sent within the range of 2 MHz.

In this embodiment, the determining module 1810 may be divided into multiple determining modules, such as a first determining module and a second determining module. The first determining module may be configured to determine that the zero-power apparatus is to use a first receiver parameter, and the second determining module may be configured to determine that the zero-power apparatus is to use a second receiver parameter. Alternatively, the first determining module may be configured to determine that the zero-power apparatus is to use a second receiver parameter, and the second determining module may be configured to determine that the zero-power apparatus is to use a first receiver parameter. The function(s) of a different determining module is not limited in embodiments of the present disclosure.

In this embodiment, the sending module 1820 may be divided into multiple sending modules, such as a first sending module, a second sending module, a third sending module, and a fourth sending module. The first sending module may be configured to send a DL signal through a channel corresponding to the first receiving bandwidth, the second sending module may be configured to send a DL signal through a channel corresponding to the second receiving bandwidth, the third sending module may be configured to broadcast a supported zero-power apparatus type or a zero-power apparatus type allowed to access, and the fourth sending module may be configured to send a common signal. Alternatively, the first sending module may be configured to broadcast the supported zero-power apparatus type or the zero-power apparatus type allowed to access, the second sending module may be configured to send the common signal, the third sending module may be configured to send a DL signal through the channel corresponding to the first receiving bandwidth, and the fourth sending module may be configured to send a DL signal through the channel corresponding to the second receiving bandwidth. The function(s) of a different sending module is not limited in embodiments of the present disclosure.

In this embodiment, the receiving module 1830 may be divided into multiple receiving modules, such as a first receiving module and a second receiving module. The first receiving module is configured to receive a UL signal sent by the zero-power apparatus, and the second receiving module is configured to receive first information sent by the zero-power apparatus. Alternatively, the first receiving module is configured to receive first information sent by the zero-power apparatus, and the second receiving module is configured to receive a UL signal sent by the zero-power apparatus. The function(s) of a different receiving module is not limited in embodiments of the present disclosure.

In embodiments of the present disclosure, one determining module 1810 is illustrated as an example, and the number of determining modules 1810 is not limited.

In embodiments of the present disclosure, one sending module 1820 is illustrated as an example, and the number of sending modules 1820 is not limited.

In embodiments of the present disclosure, one receiving module 1830 is illustrated as an example, and the number of receiving modules 1830 is not limited.

For the illustration of the function(s) of the determining module 1810, reference may be made to the operations at S730 in the embodiment as illustrated in FIG. 7 and the operations at S1210 in the embodiment as illustrated in FIG. 12.

For the illustration of the function(s) of the sending module 1820, reference may be made to the operations at S720 in the embodiment as illustrated in FIG. 7, the operations at S1210 in the embodiment as illustrated in FIG. 12, and the operations at S1410 in the embodiment as illustrated in FIG. 14.

For the illustration of the function(s) of the receiving module 1830, reference may be made to the operations at S710 and at S740 in the embodiment as illustrated in FIG. 7, the operations at S1210 in the embodiment as illustrated in FIG. 12, and the operations at S1510 in the embodiment as illustrated in FIG. 15.

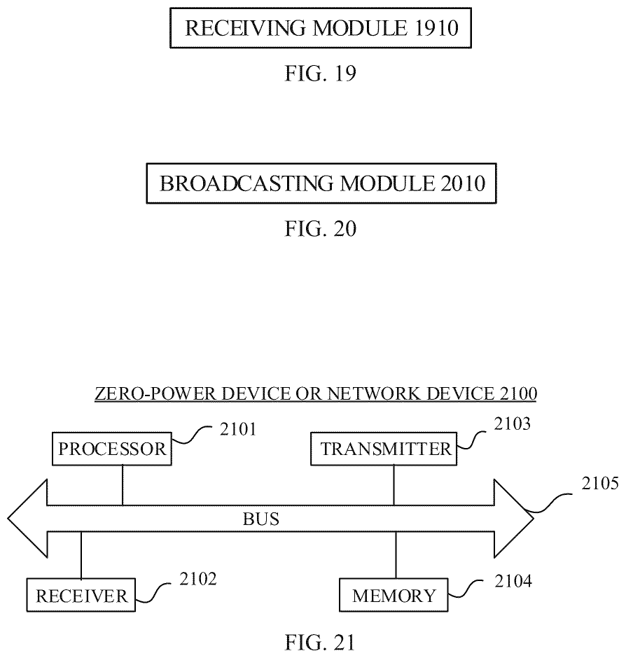

FIG. 19 is a block diagram of a network-side apparatus provided in an exemplary embodiment of the present disclosure. The network-side apparatus may be implemented as a network device or as a part of a network device through software, hardware, or a combination thereof. The network-side apparatus includes a receiving module 1910, where the function(s) of the receiving module 1910 is implemented by a receiver of the network device.

The receiving module 1910 is configured to receive first information sent by a zero-power apparatus, where the first information includes receiver capability information of the zero-power apparatus or receiver parameter information of the zero-power apparatus.

In a possible design of this embodiment, the receiver capability information or the receiver parameter information includes at least one of: first capability information, and second capability information, where the first capability information indicates a receiver type, and the second capability information indicates a receiving bandwidth.

In a possible design of this embodiment, the first capability information indicates a receiver type supported by the zero-power apparatus, and the second capability information indicates a bandwidth for signal reception.

In a possible design of this embodiment, the first capability information includes at least one of: RF-based receiver information, IF-based receiver information, and zero IF-based receiver information.

In a possible design of this embodiment, the zero-power apparatus supports any one of the above receivers, or supports both an RF-based receiver and an IF-based receiver, or supports both an RF-based receiver and a zero IF-based receiver, or supports all three types of receivers, or supports other types of receivers, which is not limited in embodiments of the present disclosure.

In a possible design of this embodiment, the second capability information includes at least one of: a first bandwidth value, a second bandwidth value, a first multiple of a channel bandwidth, and a second multiple of a channel bandwidth. The first bandwidth value or the first multiple of a channel bandwidth indicates a receiving bandwidth corresponding to an RF-based receiver. The second bandwidth value or the second multiple of a channel bandwidth indicates a receiving bandwidth corresponding to an IF-based receiver or a zero IF-based receiver. The first bandwidth value is greater than the second bandwidth value. The first multiple is greater than the second multiple, and the first multiple and the second multiple each are a positive integer.

In a possible design of this embodiment, a channel is determined based on a communication protocol and is used for sending a DL signal, and a channel bandwidth of the channel is determined based on a communication protocol. For example, one channel bandwidth is 250 kHz. Exemplarily, a receiving bandwidth of the RF-based receiver is 1000 kHz or four channel bandwidths, and a receiving bandwidth of the IF (zero IF)-based receiver is 250 kHz or one channel bandwidth.

In embodiments of the present disclosure, one receiving module 1910 is illustrated as an example, and the number of receiving modules 1910 is not limited.

For the illustration of the function(s) of the receiving module 1910, reference may be made to the operations at S720 in the embodiment as illustrated in FIG. 7, the operations at S1210 in the embodiment as illustrated in FIG. 12, and the operations at S1410 in the embodiment as illustrated in FIG. 14.

FIG. 20 is a block diagram of a network-side apparatus provided in an exemplary embodiment of the present disclosure. The network-side apparatus may be implemented as a network device or as part of a network device through software, hardware, or a combination thereof. The network-side apparatus includes a broadcasting module 2010, where the function(s) of the broadcasting module 2010 is implemented by a transmitter of the network device.

The broadcasting module 2010 is configured to broadcast a supported zero-power apparatus type or a zero-power apparatus type allowed to access.

In a possible design of this embodiment, the supported zero-power apparatus type or the zero-power apparatus type allowed to access is determined by the network-side apparatus based on a communication scenario.

In a possible design of this embodiment, the broadcasting module 2010 is configured to broadcast the supported zero-power apparatus type or the zero-power apparatus type allowed to access by sending a broadcast signal or a beacon frame signal.

In a possible design of this embodiment, the supported zero-power apparatus type or the zero-power apparatus type allowed to access is determined by the network-side apparatus based on a communication scenario (referred to as “scenario”for short).

Based on factors such as communication scenarios, performance requirements, and signal coverage, the network-side apparatus determines the supported zero-power apparatus type or the zero-power apparatus type allowed to access.

Scenario 1: in scenarios such as smart homes and wearable devices, the demand for the number of zero-power apparatus is relatively low, and users focus more on the user experience. For example, the zero-power apparatus can be powered in a short time, such that the zero-power apparatus can perform functions such as communication or positioning. When a supported receiver is an RF-based receiver, due to its lower power consumption, power supply can be achieved in a shorter time. For example, when a mobile phone is used to wirelessly power the zero-power apparatus, an application generally needs to be started to trigger the mobile phone to wirelessly power the zero-power apparatus during communication with the zero-power apparatus. If the zero-power apparatus consumes less power during operation, the time of power supply by the mobile phone can be reduced, thereby reducing the energy consumption of the mobile phone.

On the other hand, although the RF-based receiver has low sensitivity and low transmission efficiency, a sensitivity range of −20 dB to −35 dB is already a current implementation limit for wireless power supply, and the RF-based receiver can achieve a sensitivity range of −35 dB to −50 dB. Additionally, in scenarios such as smart homes where the demand for the number of zero-power apparatus is relatively low, the relatively low transmission efficiency does not affect the user experience.

Scenario 2: in scenarios such as industrial intelligence or smart control, a large number of zero-power apparatus are required for environmental monitoring, production line monitoring, and asset inventory. Given the large number of zero-power apparatus in such scenarios, it is essential to provide a relatively high throughput to facilitate communication with the zero-power apparatus. For these scenarios, the zero-power apparatus supports an IF-based receiver or a zero IF-based receiver. These two types of receivers have high sensitivity and can receive signals by using relatively narrow receiving bandwidths. As a result, more zero-power apparatus can be supported to perform communication within the same frequency band, thus achieving relatively high transmission efficiency.

Scenario 3: in some scenarios, the required number of zero-power apparatus varies. For example, in a warehouse scenario, a large number of zero-power apparatus are required, but when items are delivered from a warehouse to a supermarket, fewer zero-power apparatus are required. Therefore, for such scenarios, the zero-power apparatus supports two types of receivers: an RF-based receiver and an IF (zero IF)-based receiver. The network-side apparatus can notify the zero-power apparatus to use the appropriate receiver based on the specific scenario.

In a possible design of this embodiment, the broadcasting module 2010 is configured to broadcast the supported zero-power apparatus type or the zero-power apparatus type allowed to access is broadcast by sending a broadcast signal or a beacon frame signal.

Based on the supported zero-power apparatus type or the zero-power apparatus type allowed to access that is broadcast by the network-side apparatus, only a zero-power apparatus corresponding to the zero-power apparatus type can access the network-side apparatus, or the zero-power apparatus may adjust its used receiver to match the zero-power apparatus type supported by the network-side apparatus or the zero-power apparatus type allowed to access the network-side apparatus.

In embodiments of the present disclosure, one broadcasting module 2010 is illustrated as an example, and the number of broadcasting modules 2010 is not limited.

For the illustration of the function(s) of the broadcasting module 2010, reference may be made to the operations at S710 in the embodiment as illustrated in FIG. 7, the operations at S1210 in the embodiment as illustrated in FIG. 12, and the operations at S1510 in the embodiment as illustrated in FIG. 15.

FIG. 21 is a schematic structural diagram of a zero-power device or network device 2100 provided in an exemplary embodiment of the present disclosure. The zero-power device or network device 2100 includes a processor 2101, a receiver 2102, a transmitter 2103, a memory 2104, and a bus 2105.

The processor 2101 includes one or more processing cores, and the processor 2101 executes various function applications and information processing by running software programs and modules. In some embodiments, the processor 2101 can be configured to implement the functions and operations of at least one of the determining module 1610 and the determining module 1810.

The receiver 2102 and the transmitter 2103 may be implemented as a communication assembly, and the communication assembly may be a communication chip. The communication chip may also be referred to as a transceiver. In some embodiments, the receiver 2102 can be configured to implement the functions and operations of at least one of the receiving module 1620, the receiving module 1830, and the receiving module 1910. The transmitter 2103 can be configured to implement the functions and operations of at least one of the sending module 1630, the sending module 1710, the sending module 1820, and the broadcasting module 2010.

The memory 2104 is connected to the processor 2101 via the bus 2105.

The memory 2104 can be configured to store at least one instruction, and the processor 2101 is configured to execute the at least one instruction, to implement the various operations in the method embodiments mentioned above.

In addition, the memory 2104 may be implemented by any type of volatile storage device, non-volatile storage device, or a combination thereof. The volatile storage device or non-volatile storage device includes, but is not limited to, a magnetic disk or an optical disk, an electrically erasable programmable read-only memory (EEPROM), an erasable programmable read-only memory (EPROM), a static random-access memory (SRAM), a read-only memory (ROM), a magnetic memory, a flash memory, and a programmable read-only memory (PROM).

In some embodiments, the receiver 2102 independently receives signals/data, or the processor 2101 controls the receiver 2102 to receive signals/data, or the processor 2101 requests the receiver 2102 to receive signals/data, or the processor 2101 cooperates with the receiver 2102 to receive signals/data.

In some embodiments, the transmitter 2103 independently transmits signals/data, or the processor 2101 controls the transmitter 2103 to transmit signals/data, or the processor 2101 requests the transmitter 2103 to transmit signals/data, or the processor 2101 cooperates with the transmitter 2103 to transmit signals/data.

In an exemplary embodiment, a computer-readable storage medium is further provided. The computer-readable storage medium is configured to store at least one program, and the at least one program is loaded and executed by a processor to implement the method for determining the receiver parameter and the method for information transmission provided in the method embodiments mentioned above.

In an exemplary embodiment, a computer program product or a computer program is further provided. When executed on a processor, the computer program product or the computer program causes the zero-power device or network device 2100 to implement the method for determining the receiver parameter and the method for information transmission provided in the method embodiments mentioned above.

It will be understood by those of ordinary skill in the art that, all or some of the steps in the foregoing embodiments may be accomplished by means of hardware, or a program to instruct associated hardware. The program may be stored in a computer-readable storage medium. The storage medium may be a ROM, a magnetic disk, or an optical disk, etc.

The foregoing elaborations are merely optional embodiments of the present disclosure, and are not intended to limit the present disclosure. Any modification, equivalent replacement, and improvement made within the concept and principle of the present disclosure shall fall within the protection scope of the present disclosure.

What is claimed is:

1. A method for determining a receiver parameter, performed by a zero-power device and comprising:
determining a receiver parameter to be used by the zero-power device, wherein the receiver parameter comprises at least one of a receiver type and a receiving bandwidth.

2. The method of claim 1, wherein:
the zero-power device supports at least two receivers, or the zero-power device supports at least two types of receiver parameters; and
the receiver parameter is determined based on a notification message sent by a network device.

3. The method of claim 1, wherein:
the zero-power device supports at least two receivers, or the zero-power device supports at least two types of receiver parameters; and
the receiver parameter is determined based on a communication process.

4. The method of claim 3, wherein determining the receiver parameter to be used by the zero-power device comprises:
determining that the zero-power device is to use a first receiver parameter in a case where the communication process is a first communication process,
wherein the first communication process comprises a cell search process or a beacon frame signal scan process, and the first receiver parameter comprises at least one of a first receiver type and a first receiving bandwidth.

5. The method of claim 3, wherein determining the receiver parameter to be used by the zero-power device comprises:
determining that the zero-power device is to use a second receiver parameter in a case where the communication process is a second communication process,
wherein the second communication process comprises a data communication process, and the second receiver parameter comprises at least one of a second receiver type and a second receiving bandwidth.

6. The method of claim 4, wherein the first receiver type is a radio frequency (RF)-based receiver type.

7. The method of claim 5, wherein the second receiver type is an intermediate frequency (IF)-based receiver type or a zero IF-based receiver type.

8. The method of claim 4, further comprising:
receiving a downlink (DL) signal sent by a network device in a case where the zero-power device uses the first receiver parameter.

9. The method of claim 8, wherein receiving the DL signal sent by the network device in the case where the zero-power device uses the first receiver parameter comprises:
receiving the DL signal sent by the network device through one channel in a channel group in the case where the zero-power device uses the first receiver parameter, wherein the channel group contains at least two channels; or
receiving the DL signal through a channel corresponding to the first receiving bandwidth in the case where the zero-power device uses the first receiver parameter.

10. The method of claim 1, further comprising:
sending first information, wherein the first information comprises receiver capability information of the zero-power device or receiver parameter information of the zero-power device;
wherein the receiver capability information or the receiver parameter information comprises at least one of:
first capability information; and
second capability information;
wherein the first capability information indicates a receiver type, and the second capability information indicates a receiving bandwidth.

11. The method of claim 10, wherein the first capability information comprises at least one of:
RF-based receiver information;
IF-based receiver information; and
zero IF-based receiver information.

12. A zero-power device, comprising:
a processor; and
a memory configured to store executable instructions which, when executed by the processor, causes the zero-power device to:
determine a receiver parameter to be used by the zero-power device, wherein the receiver parameter comprises at least one of a receiver type and a receiving bandwidth.

13. The zero-power device of claim 12, wherein:
the zero-power device supports at least two receivers, or the zero-power device supports at least two types of receiver parameters; and
the receiver parameter is determined based on a notification message sent by a network device.

14. The zero-power device of claim 12, wherein:
the zero-power device supports at least two receivers, or the zero-power device supports at least two types of receiver parameters; and
the receiver parameter is determined based on a communication process.

15. The zero-power device of claim 14, wherein the executable instructions executed by the processor to cause the zero-power device to determine the receiver parameter to be used by the zero-power device are executed by the processor to cause the zero-power device to:
determine that the zero-power device is to use a first receiver parameter in a case where the communication process is a first communication process,
wherein the first communication process comprises a cell search process or a beacon frame signal scan process, and the first receiver parameter comprises at least one of a first receiver type and a first receiving bandwidth.

16. The zero-power device of claim 14, wherein the executable instructions executed by the processor to cause the zero-power device to determine the receiver parameter to be used by the zero-power device are executed by the processor to cause the zero-power device to:
determine that the zero-power device is to use a second receiver parameter in a case where the communication process is a second communication process,
wherein the second communication process comprises a data communication process, and the second receiver parameter comprises a second receiver type and/or a second receiving bandwidth.

17. A network device, comprising:
a processor; and
a memory configured to store executable instructions which, when executed by the processor, causes the network device to:
determine a receiver parameter to be used by a zero-power device, wherein the receiver parameter comprises at least one of a receiver type and a receiving bandwidth.

18. The network device of claim 17, wherein:
the zero-power device supports at least two receivers, or the zero-power device supports at least two types of receiver parameters; and
the executable instructions are further executed by the processor to cause the network device to:
send a notification message to the zero-power device, wherein the notification message indicates the receiver parameter.

19. The network device of claim 17, wherein:
the zero-power device supports at least two receivers, or the zero-power device supports at least two types of receiver parameters; and
the receiver parameter is determined based on a communication process.

20. The network device of claim 19, wherein the executable instructions executed by the processor to cause the network device to determine the receiver to be used by the zero-power device is executed by the processor to cause the network device:
determining that the zero-power device is to use a first receiver parameter in a case where the communication process is a first communication process,
wherein the first communication process comprises a cell search process or a beacon frame signal scan process, and the first receiver parameter comprises a first receiver type and/or a first receiving bandwidth.
